(19) United States
(12) Patent Application Publication
(10) Pub. No.: US 2022/0222065 A1
(43) Pub. Date: Jul. 14, 2022

(54) SYSTEM AND METHOD OF COMPUTER-ASSISTED COMPUTER PROGRAMMING

(71) Applicant: AI GAMES LTD, Herzlia (IL)

(72) Inventor: Amon TAVOR, Hod Hasharon (IL)

(21) Appl. No.: 17/610,056

(22) PCT Filed: May 7, 2020
(86) PCT No.: PCT/IL2020/050503

§ 371 Date: Nov. 9, 2021

Related U.S. Application Data
(60) Provisional application No. 62/845,902, filed on May 10, 2019.

(51) Int. Cl. G06F 8/65; G06F 8/30; G06F 8/41; G06F 9/455

(52) U.S. Cl. CPC G06F 8/65; G06F 8/31; G06F 2009/4557; G06F 9/45558; G06F 8/427

(57) ABSTRACT

Systems and methods of computer-assisted programming, including: storing, on a computer memory, a program code, displaying the program code, receiving, from a user, a mark of a location in the displayed program code, producing a list of selectable program elements that are valid for insertion into the program code at the marked location, in accordance with one or more rules of a programming language, receiving, from the user, a selection of at least one program element from the list of selectable program elements, inserting the at least one selected program element into said program code in the computer memory, at a location corresponding to the marked location received from the user, and preventing the user from inserting a program element into the stored program code in any way that is devoid of selection of at least one selectable program element from the list of selectable valid program elements.

### FIELD OF THE INVENTION

The present invention relates generally to producing computer code. More specifically, the present invention relates to using computer-assisted programming to produce error-free computer code.

### BACKGROUND OF THE INVENTION

Since the advent of electronic computers in the 1960's, they have become increasingly powerful and ubiquitous. Currently, major advances have been accomplished in computer programming languages and paradigms. However, the methods of feeding programs into the computer changed very little since the days of punch cards. A programmer typically writes a program source code in a human-intelligible language in text form, and a computer program such as a compiler may parse and interpret the text, in an attempt to translate it into executable computer instructions, commonly referred to as machine code.

Since formal programming languages have strict rules, even a simple program written by a human programmer is likely to contain numerous errors such as typos and grammatical errors. Such errors normally result in the complier rejecting the source code, forcing the programmer to fix the mistakes and resubmit his source code for compilation, over and over again. This cumbersome process consumes a majority of programmers' time, and is especially frustrating to less experienced programmers.

Some attempts have been made to alleviate this problem, by assisting the programmer during the typing of source code. Such attempts include, for example, automatic completion of typed instructions, or use of simple code templates. While occasionally preventing typos, these methods do not prevent the programmer from typing erroneous code, and do not ensure correct grammar and program structure prior to compilation.

Another such attempt to mitigate this problem includes usage of visual programming languages. Such languages enable programmers to create programs by manipulating visual representations of program elements, in the form of icons or labeled boxes, where the spatial relationships of the program elements (or instructions) and the connections therebetween, purportedly determine the flow of the program.

Although this method may prevent a user from typing mistakes, and may also seem intuitive at first, it may be appreciated by a person skilled in the art that visual programming language may not support scalability of the written code. For example, as the program becomes large and elaborate, the task of following and manipulating the visual structure of the program becomes increasingly strenuous. Therefore, visual programming is mainly used for teaching basic programming, and is highly controversial for habituating students to specialized languages and impractical programming paradigms.

### SUMMARY OF THE INVENTION

A system and a method for creating computer programs without typing code and without producing syntax errors, but also without compromising the elaborate structure and expressive syntax achievable by using formal, high-level programming languages may therefore be desired.

There is thus provided, in accordance with some embodiments of the invention, a method of computer-assisted programming, the method including: storing, on a computer memory, a program code, displaying the program code to a user, receiving, from the user, a mark of a location in the displayed program code, producing a list of selectable program elements that are valid for insertion into the program code at the marked location, in accordance with one or more rules of a programming language, receiving, from the user, a selection of at least one program element from the list of selectable program elements, inserting the at least one selected program element into said program code in the computer memory, at a location corresponding to the marked location received from the user, and preventing the user from inserting a program element into the stored program code in any way that may be devoid of selection of at least one selectable program element from the list of selectable valid program elements.

In some embodiments, the method may include updating the display of program code, based on the program code stored in the computer memory, to include the at least one inserted program element.

In some embodiments, the program code stored on computer memory may be in a first format, that may include a structured program code model, and the program code displayed to the user may be in a second format, that may include high-level, human-intelligible text of the programming language.

In some embodiments, at least one selected program element may be inserted into the stored program code in the first format, and the method further includes identifying a change in the stored program code, and translating at least one portion of the stored program code, including the change, from the first format into the second format.

In some embodiments, producing the list of selectable, valid program elements includes: traversing a list of available program elements, for one or more program elements of the list of available program elements, traversing over rules of the programming language, and determining whether the relevant program element complies with the rules, and is thus valid for insertion at the location of the insertion point.

In some embodiments, receiving, from the user, a selection of at least one program element includes: accumulating one or more program elements that are valid for insertion at said insertion point in a list, sorting the list of program elements according to the at least one category of the program elements, displaying the list of program elements, and receiving, from the user, a selection of at least one program element from the displayed list.

There is thus provided, in accordance with some embodiments of the invention, a method of computer-assisted programming, the method including: displaying a program code to a user, obtaining, from the user, an insertion location in said displayed program code, producing a list of selectable program elements, that are valid for insertion at the insertion location, in accordance with one or more rules of a programming language, receiving, from the user, a selection of at least one program element from the list of selectable program elements, and solely based on the received selection of a program element, inserting the at least one selected program element into the program code, at the insertion location.

In some embodiments, the program code may be displayed to the user as high-level, human intelligible text of a programming language.

In some embodiments, the selectable program elements are presented to the user as high-level, human intelligible text of a programming language.

In some embodiments, the method further including preventing the user from inserting a program element into the program code in any way that is devoid of the selection of the at least one selectable, program element from the list of selectable program elements.

In some embodiments, the insertion location indicates at least one specific program element in the program code, and the method further includes: producing a list of selectable actions, that are valid for application at said insertion location, based on a type of the specific program element, receiving, from the user, a selection of at least one action of the list of selectable actions, and applying the at least one selected action on the program code, at the insertion location, in accordance with the one or more rules of the programming language.

In some embodiments, the list of selectable actions may be selected from a list consisting: changing a value of the indicated program element, naming a symbol of an indicated program element; changing a symbol name of the indicated program element, deleting the indicated program element from the program code, copying the indicated program element, and moving the indicated program element in the program code.

In some embodiments, the selected at least one action may include, for example naming a symbol of the indicated program element, and applying the at least one selected action on the program code may include: receiving, from a user, a new name for the indicated program element, validating the newly received symbol name in accordance with the one or more rules of the programming language, and inserting the newly received symbol name into the program code, based on said validation.

In some embodiments, validating the newly received symbol name may be selected from a list consisting of: validating the newly received symbol name to avoid a condition of ambiguity in the program code, validating the newly received symbol name to avoid usage of reserved keywords, and validating the newly received symbol name to avoid usage of illegal symbols.

In some embodiments, the selected at least one action includes deletion of the indicated program element from the program code, and wherein applying the at least one selected action may include, for example, validating the deletion of the indicated program element in accordance with the one or more rules of the programming language; and omitting the indicated program element from the program code, based on the validation.

In some embodiments, validating the deletion of a first, indicated program element may include determining whether the first program element includes a hierarchical structure that includes at least one second program element, and wherein deleting the first program element from the program code further may include deleting the at least one second program element from the program code.

In some embodiments, validating the deletion of a first, indicated program element may include: determining whether the first program element is comprised within a hierarchical structure of a second program element; and determining, whether the second program element requires the first program element according to the one or more rules of the programming language, and deleting the first program element from the program code further may include replacing the first program element with a placeholder; and prompting the user to add a program element at the location of the placeholder.

In some embodiments, validating the deletion of a first, indicated program element may include determining whether the first program element is not referenced by one or more second program elements in the program code.

In some embodiments, validating the deletion of a first, indicated program element may include: identifying one or more second program element having intertwined relations with the first program element; and analyzing the intertwined relationship between the first, indicated program element and the one or more second program elements in view of the one or more rules of the programming language, and wherein applying the deletion action on the first program element further may include applying a deletion action on the one or more second, intertwined program elements according to the analysis.

In some embodiments, the selected at least one action may include moving at least one indicated program element in the program code, and applying the at least one selected action may include: validating the movement of the at least one indicated program element in accordance with the one or more rules of the programming language; and moving the at least one indicated program element in the program code, based on said validation.

In some embodiments, validation of movement of the at least one indicated program element may include at least one of: determining that the moved program element is not required in its old location in the program code; determining that the moved program element is valid for insertion at its new location in the program code; determining, in a condition that the at least one program element is a symbol declaration, that the symbol can be declared in the new location without producing a conflict with an existing symbol; and determining, in a condition that the program element is referenced by one or more second program elements in the program code, that the new location is within the scope of each of the one or more second program elements

There is thus provided, in accordance with some embodiments of the invention, a system for computer-assisted computer programming, the system including: a non-transitory memory device, wherein modules of instruction code are stored, and at least one processor associated with the memory device, and configured to execute the modules of instruction code. For the execution of the modules of instruction code, the at least one processor is configured to: display a program code to a user, obtain, from the user, an insertion location in said displayed program code, produce a list of selectable program elements, that are valid for insertion at the insertion location, in accordance with one or more rules of a programming language, receive, from the user, a selection of at least one program element from the list of selectable program elements, and solely based on the received selection of a program element, insert the at least one selected program element into the program code, at the insertion location.

There is thus provided, in accordance with some embodiments of the invention, a method of computer-assisted programming, including: maintaining, on a computer memory, a first representation of a program code, obtaining, via a user interface, a selection of at least one textual program element and a corresponding insertion location in the program code, updating the first representation, to include the selected at least one textual program element at the insertion location, translating the first representation to produce a second representation of the program code, and displaying the second representation on a user interface.

In some embodiments, the first representation is formatted as an intermediary-level program code representation, and the representation is formatted as textual, user-level programming language representation.

In some embodiments, obtaining the selection of the at least one program element and the corresponding insertion location includes: receiving, via the user interface, a selection of a first insertion location in the user-level programming language representation, identifying a second insertion location, in the intermediary-level program code representation that corresponds to the first insertion location, presenting, via the user interface, a list of selectable program elements, that are valid for insertion at the second insertion location, according to rules pertaining to a programming language, and receiving, via the user interface, the selection of the at least one textual program element from the list of selectable, valid program elements.

In some embodiments, the selectable program elements are presented to the user as high-level, human intelligible text of a programming language.

Embodiments of the invention may include executing the intermediary-level program code representation on a computing device without requiring compilation or parsing of source code.

In some embodiments, translating the first representation of the intermediary-level program code format to a second the representation of the high-level program code format further may include creating a location table, associating a user-marked location with corresponding program elements in the first representation of the intermediate-level code format, and wherein identifying the second insertion location corresponding to the first insertion location may be done based on the location table.

In some embodiments, the intermediate-level program code may be structured as a hierarchical structured program code model, representing a hierarchical structure of the program code.

Embodiments of the invention may include determining a context of one or more program elements according to the hierarchical structured program code model.

Embodiments of the invention may include determining a scope of one or more symbols of program elements in the program code according to the hierarchical structured program code model.

Embodiments of the invention may include: for each first program element of the program code, which refers a second program element of the program code, storing a reference to the second program element within the hierarchical structured program code model; and accessing the second program element via said reference.

Embodiments of the invention may include maintaining one or more symbol scope tables, defining a scope of each program element within the program code; and using the one or more symbol scope tables to detect conflicts among program elements within the program code.

There is thus provided, in accordance with some embodiments of the invention, a method for computer-assisted computer programming, including: storing written program code using intermediate language, displaying program to user as intelligible source code, allowing user to select location in program to add an instruction, producing by computer function a list of valid instructions to be placed at selected location according to programming language rules, displaying list of valid instructions to user and allowing user to select one, inserting selected instruction into written program, and updating program display accordingly.

In some embodiments the displayed list of valid instructions may be divided into categories.

In some embodiments, following the insertion of an instruction, the next logical insertion location in the written program may be automatically selected.

In some embodiments, the insertion of an instruction which entails additional instructions or parameters may require user to also insert said parameters.

In some embodiments, the insertion of an instruction which entails additional instructions or parameters may create placeholders in the program for said parameters.

In some embodiments, the user may select at least one existing program instructions and delete them, providing the remaining instructions still constitute a valid program structure.

In some embodiments, the user may select at least one existing program instructions and delete them, while automatically replacing them with placeholders if they are required to maintain valid program structure.

In some embodiments, the user is prohibited from executing the written program while the program contains at least one placeholder.

In some embodiments, the insertion of an instruction which declares a program symbol may allow the user to enter a name for said symbol, while asserting that entered name is valid for said declared program symbol according to the language syntax.

In some embodiments, the user may select an existing program instruction which declares a program symbol, and may rename said selected symbol, while asserting that the newly entered name is valid for said declared program symbol according to the language syntax.

In some embodiments, the insertion of an instruction which defines a program value may allow user to enter said value, while asserting that entered value complies with the requirements of the program.

In some embodiments, the user may select an existing program element which defines a program value, and may edit said selected value, while asserting that newly entered value complies with the requirements of the program.

In some embodiments, the user may select an existing program instruction and may replace it with another instruction from a newly displayed list of valid instructions for same location.

In some embodiments, the user may select at least one existing program instructions, may copy them, and may paste them in another location, if their assimilation in said location will still constitute a valid program.

In some embodiments, the written intermediate language may be executed by a virtual machine.

In some embodiments, the intermediate language may be transferred to, and execute on, other computers and operating systems.

In some embodiments, the written intermediate language program may be compiled into machine code by straightforward translation of intermediate language instructions into correlating machine language instructions.

In some embodiments, the displayed source code may be in the form of a known programming language, and the source code may be exported as source file that can be used in a standard programming environment and compiled by a standard compiler.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for computer-assisted programming, according to some embodiments of the invention;

FIG. 2 is a high-level flow diagram, depicting a method of computer-assisted computer programming, according to some embodiments of the invention;

FIG. 3A is a non-limiting example for using computer-assisted computer programming, according to some embodiments of the invention;

FIG. 3B is another non-limiting example for using computer-assisted computer programming, according to some embodiments of the invention;

FIG. 4A is a high-level block diagram, depicting a system for computer-assisted computer programming, according to some embodiments of the invention;

FIG. 4B is another a high-level block diagram, depicting a system for computer-assisted computer programming, according to some embodiments of the invention; and

FIG. 5 is a flow diagram, depicting a method of computer-assisted programming, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method and a system for creating computer programs without typing code and without producing syntax errors, but also without compromising the elaborate structure and expressive syntax achievable by using formal, high-level programming languages.

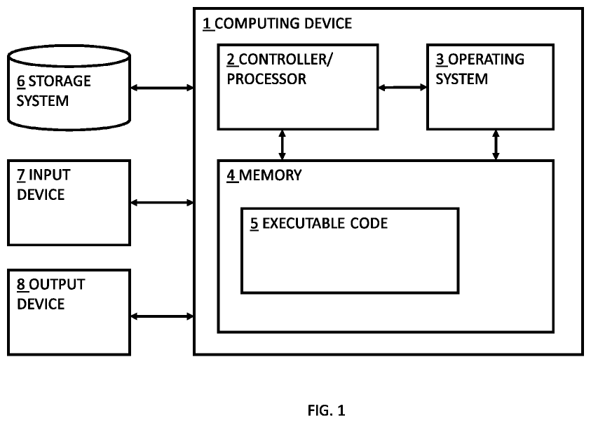

Reference is now made to FIG. 1, which is a block diagram depicting a computing device, which may be included within an embodiment of a system for computer-assisted computer programming, according to some embodiments.

Computing device 1 may include one or more controllers or processors 2 (e.g., possibly across multiple units or devices) that may be, for example, a central processing unit (CPU) processor, a processing chip or any suitable computing or computational device, an operating system 3, a memory 4, executable code 5, a storage system 6, input devices 7 and output devices 8.

The one or more controller or processor 2 may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by controller 2 possibly under control of operating system 3. For example, executable code 5 may be an application that may produce a computer program as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to creation of a computer code may be stored in storage system 6 and may be loaded from storage system 6 into memory 4 where it may be processed by controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers, and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

The following table, Table 1, includes a list of references to terms that may be used throughout this document.

TABLE 1

| | |
|---|---|
| Program | The term “program code” may be used herein to refer to a data |
| code | element that may pertain to programming of a computer device |
| | (e.g., element 1 of FIG. 1). The term “program code” may be |
| | context driven, in a sense that it may refer to different types or |
| | formats of data, according to the corresponding context. |
| | For example, program code may refer to different formats of |
| | textual objects, including for example: a high-level program code |
| | format, an intermediary-level program code format and machine- |
| | code format. |
| High-level | The term “high-level” may be used herein in relation to a |
| program | program code to indicate a program code that may be formatted |
| code | as human-intelligible text. For example, a high-level program |
| | code may be or may include text that is formatted as a high level |
| | programming language (e.g., Java, C, C++, etc.) and may comply |
| | with rules or standards of such languages. |
| Intermediate- | The term “intermediary-level” may be used herein in relation to |
| level | a program code to indicate program code that is of a format |
| program | distinguishable from high-level program code format. |
| code | For example, an intermediary-level program code may not be |
| | human-intelligible, but may nevertheless be processed and/or |
| | utilized by a computing device to perform one or more |
| | programmed tasks and/or processes. |
| | It may be appreciated by a person skilled in the art that a high- |
| | level program code, which may normally be written by a human |
| | programmer, may need to be parsed, analyzed, and/or checked |
| | for errors (e.g., by a compiler). In contrast, an intermediate-level |
| | program code will normally be produced by a computer (e.g., by |
| | a front-end compiler), and can be assumed to be devoid of errors |
| | such as syntax errors. |
| Program | The terms “program element” and “program code element” may |
| element, | be used herein interchangeably to refer to elements and/or |
| Program | entities that may constitute a program code. |
| code | For example, program code of currently available programming |
| element | languages may include program elements such as: declarations |
| | (e.g., of variables, functions, types, etc.), values (e.g., numbers, |
| | strings, etc.), flow-control statements (e.g., loop statements, |
| | condition statements), function calls, operators, assignments, |
| | parameters, lists, program blocks, comments, and the like. |
| Structured | The term “structured program code model” or “code model” in |
| program | short, may be used herein to indicate a data structure that may |
| code model | include objects that describe or hold information pertaining to |
| | program elements of an intermediate-level program code. |
| | According to some embodiments, the structured program code |
| | model may be stored or maintained in the “background”, and |
| | may be utilized to apply changes in the program code in an |
| | intermediate-level format. The structured program code model |
| | may subsequently be translated to high-level, human intelligible |
| | text, to enable interaction with a user, as elaborated herein. |
| | According to some embodiments, the structured program code |
| | model (or “code model”) may be arranged in a hierarchical |
| | structure (e.g., a tree structure), where at least one parent object |
| | may include one or more child objects, either by direct inclusion |
| | or by reference. In some embodiments, these relations of |
| | inclusion or reference between objects of the structured program |
| | code model may be: (a) unidirectional in one direction (e.g., |
| | parent elements may refer to their child elements); (b) |
| | unidirectional in another direction (e.g., child elements may refer |
| | to their parent element), and (c) any combination thereof (e.g., |
| | bidirectionally, where parent elements and child element |
| | mutually refer to each other). Such references may be |
| | implemented, for example, by memory pointers, positions in a |
| | list, and/or unique element identifiers. |
| Program | The term “program block” may be used herein to refer to a |
| block | program element which may include a group of separate sub- |
| | elements. It may be appreciated that in many currently available |
| | high-level programming languages, a program block may be |
| | indicated by a pair of curly brackets, that may encapsulate a |
| | plurality of program elements that may be displayed separately |
| | (e.g., by new lines and/or dedicated symbols such as semicolons). |
| | For example, a program block may be a portion of a program |
| | code that may contain one or more program elements that are |
| | declarations (e.g., declarations of global variables, declarations |
| | of functions, declarations of types, etc.). |
| | In another example, a program block that is a body of a |
| | declaration of a class (or struct) entity may include one or more |
| | program elements that are declarations of members of the class |
| | (or struct). |
| | In yet another example, a program block that is a body of a |
| | function or a flow-control statement (e.g., a conditional |
| | statement, a loop statement, etc.) may include one or more |
| | program elements that are declarations of local variables, |
| | executable statements, instructions, etc. |
| Value | The term “value element” may be used herein to describe any |
| element | kind of program element which may hold a value (e.g., a numeric |
| | value or numeric literal, a text string or string literal, a symbol |
| | name, a comment, etc.) that can be entered or changed by a user. |
| | As elaborated herein, in contrast to other program elements (e.g., |
| | statements) value elements may be devoid of instruction code |
| | elements. Therefore, embodiments of the invention may allow a |
| | user to enter or edit program elements that are value elements |
| | (e.g., by typing their value). Embodiments of the invention may |
| | subsequently apply some parsing or checking of such values |
| | entered by the user. For example embodiments of the invention |
| | may perform validation of the format and/or range of a value |
| | element that is a numeric literal. |
| Placeholder | The term “placeholder element” may be used herein to describe |
| element | a type of program element that may be utilized temporarily in a |
| | structured program code model, in place of a missing program |
| | element. In other words, a placeholder element, may temporarily |
| | substitute one or more program elements that may be required by |
| | rules of the programming language, but have not yet been |
| | inserted or chosen by a user. |
| | For example, as known in the art, a ‘while’ loop statement |
| | requires a condition element. Therefore, in a condition that a user |
| | chooses to insert a program element that is a ‘while’ loop |
| | statement, in a selected location, embodiments of the invention |
| | may automatically create a placeholder element, and insert the |
| | placeholder element in the structured program code model (e.g., |
| | in the ‘background’) at the selected location, to fill in the place |
| | of a missing condition element, until one is inserted. |
| | In a foreground representation of program code, a placeholder |
| | element may be distinguished from ‘normal’ (e.g., non-temporal) |
| | program code elements, by using a special display style (e.g. |
| | font, color, and the like). |
| | As elaborated herein, a placeholder element may not be valid for |
| | execution. Hence, the user may be prohibited from executing a |
| | program if it contains one or more placeholder elements. |
| Marked | The term “marked location” may be used herein to indicate a |
| location, | position at which a user has chosen to insert code (e.g., code |
| Insertion | representing a program element) into the program code. |
| location, | The terms “insertion location” and “insertion point” maybe used |
| Insertion | herein interchangeably, to indicate a valid position at which an |
| point, | embodiment of the invention may enable the user to insert code |
| | (e.g., code representing the program element) into the program |
| | code. |
| | As elaborated herein, a user may mark a specific location in the |
| | program code, and embodiments of the invention may |
| | subsequently (a) check the validity of the marked location and |
| | (b) produce an insertion according to the marked location (e.g., |
| | at the marked location or at the vicinity of the marked location). |
| | As elaborated herein, a first insertion point, that may be selected |
| | by the user and in a foreground, displayed (e.g., high-level) |
| | instance of a program code, may be correlated to a second |
| | insertion point, in a background stored (e.g., intermediary-level) |
| | instance of the program code. The term insertion point may thus |
| | refer to either instance of the program code or to both instances |
| | of the program code, depending on context. |
| Programming | The terms “programming rules” and “language rules”, as well as |
| rules, | “language constraints” and “language requirements”, may be |
| Language | used herein interchangeably, to indicate a set of rules that may be |
| rules, | applicable to specific types of program elements in relation to a |
| Language | specific, relevant programming language. |
| constraints, | For example, as known in the art, currently available |
| Language | programming languages (e.g. the standard C language) may |
| requirements | include a programming rule that dictates that a ‘while’ loop |
| | statement must include a condition expression and a body block. |
| | In another, related example, programming rule may dictate that |
| | a ‘continue’ instruction can only be used inside the body block |
| | of a loop statement. |
| Program | The term “program symbol” may be used herein to describe a |
| symbol | name or an identification of a declared program element. Such |
| | program symbol may, for example, be used by one or more first |
| | program elements in a high-level program code to refer to a |
| | second program element, that is identified by the program |
| | symbol. |
| | For example, a program symbol may be or may include, a name |
| | of a declared variable, a name of a constant, a name of a function, |
| | a name of an operator, a name of a type, a name of type members, |
| | labels, and the like. |
| | As known in the art, program symbols are commonly represented |
| | by human-intelligible names, for convenience. However, for the |
| | purpose of executing the program, these names are substantially |
| | insignificant. Hence, as elaborated herein, embodiments of the |
| | invention may allow a user may to type or input symbol names. |
| | Additionally, embodiments of the invention may perform |
| | validation of the inserted program symbol (e.g., to conform to |
| | symbol naming conventions, to prevent duplicate symbols, etc.) |
| | and allow the user to insert or edit the program symbols based on |
| | this validation (e.g., allow insertion of a program symbol only if |
| | the validation is successful). |
| Symbol | The term “program symbol scope”, or in short “symbol scope”, |
| scope | may be used herein to describe the relevant area in the program |
| | where a certain declared symbol may be accessible. |
| | As known in the art, utilization of symbol scopes may be |
| | beneficial for reducing code clutter, by allowing the same |
| | program symbol to be used in different contexts of the program |
| | without conflict. |
| | For example, a program element that is a variable, that may be |
| | declared inside (e.g., be ‘local’ to) a first program block, and may |
| | be identified by a fust program symbol (e.g., a variable name) |
| | may only be accessed by other elements that are defined within |
| | the same symbol scope (e.g., inside the same program block). |
| Symbol_table | The term “symbol table” may be used herein to describe a table |
| | that may be used, according to some embodiments, for tracking |
| | one or more (e.g., all) program symbols that are declared in a |
| | scope of a specific program block. |
| | According to some embodiments, a symbol table may be |
| | associated with one or more (e.g., each) program blocks in a |
| | program code, and may correlate (e.g., by reference) between one |
| | or more (e.g., each) program symbols within the program block |
| | and corresponding declarations (e.g., program elements that are |
| | declarations) thereof. |
| | According to some embodiments, a symbol table may be updated |
| | or changed whenever a symbol declaration is added, changed, or |
| | removed in the associated program block. |
| Symbol | The term “program symbol database”, or in short “symbol |
| database | database”, may be used herein to describe a collection of all |
| | symbols available in a program, according to some |
| | embodiments. For example, a program symbol database may be |
| | a unification of all the symbol tables associated with the program. |
| | As elaborated herein, a first symbol database may, for example, |
| | be maintained for symbols that are declared in a user's program |
| | code, and another database may contain or pertain to symbols |
| | that may be declared in an external code, such as program code |
| | that originates from imported libraries, application programming |
| | interfaces (APIs) and system development kits (SDKs). |

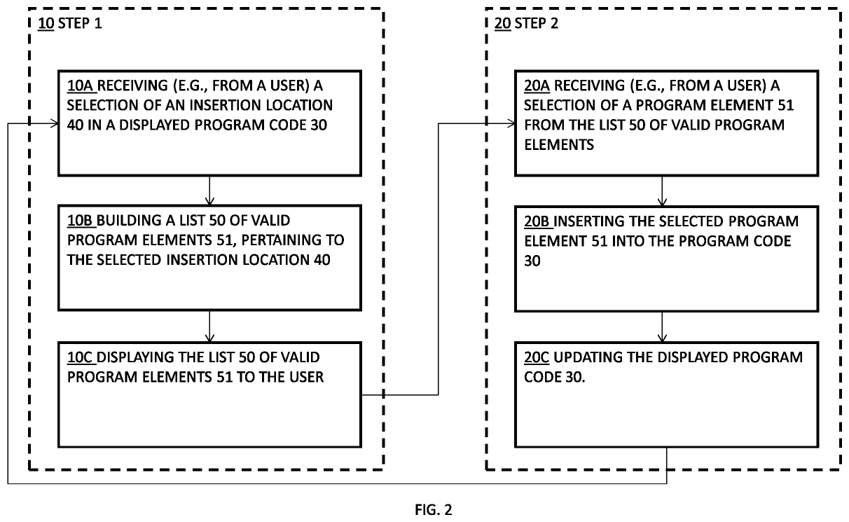

Reference is now made to FIG. 2 which is a high level flow diagram, depicting a method of computer-assisted computer programming, according to some embodiments of the invention.

As shown in FIG. 2, embodiments of the invention may include a programming workflow, that may consist of two steps; a first step 10 (marked “step 1”) and a second step 20 (marked “step 2”). Each of steps 10 and 20 may include one or more sub steps (e.g., sub steps 10A, 10B and 10C for first step 10 and sub steps 20A, 20B and 20C for second step 20). As elaborated herein, in first step 10, a location in a program code may be marked, and in second step 20 a program element may be inserted into the program code. According to some embodiments, the programming workflow may be repetitive. For example, first step 10 and second step 20 may continue, repeat, or iterate until such time that a user may choose to stop the programming workflow.

In the beginning of each cycle or repetition, a program code 30 data element may be displayed or presented on an output device (e.g., element 8 of FIG. 1), such as a computer screen.

It may be appreciated that, in an initial stage (e.g., at the beginning of the programming process), the program code may be or may include, for example a blank text data element. Alternatively, in the initial stage the program code may include a default text data element that may correspond to a specific programming language (e.g., text that may describe inclusion of standard libraries, definition of default variables, and the like). As the programming workflow proceeds, program code 30 data element may include additional text that may, for example, represent or describe program elements (e.g., names of variables, functions, data structures, etc.).

As shown in sub step 10A, and as elaborated further herein, embodiments of the invention may obtain (e.g., from a user), a selection of an insertion location 40 in the displayed program code 30. For example, a user may use an input device (e.g., element 7 of FIG. 1) such as a computer mouse, to select or mark a location for editing code (e.g., inserting one or more program elements) in the displayed program code 30.

As shown in sub step 10B, embodiments of the invention may produce a list 50 of program elements, that may be valid for insertion at the selected insertion location 40 in the displayed program code 30. For example, as elaborated herein, embodiments of the invention may include one or more computer processes or functions that may be adapted to produce a list of selectable program elements (e.g., variable names, function names, specific fields in a data structure, and the like) that may be valid for insertion at the selected insertion location 40, so as to comply with rules (e.g., syntax rules) of the programming language.

As shown in sub step 10C, embodiments of the invention may display (e.g., on output device 8) the list 50 of valid program elements.

As shown in sub step 20A, embodiments of the invention may receive (e.g., from the user), a selection of a program element from the list of valid program elements. For example, the list may be displayed to the user via a computer screen, and may enable the user to select, by an input device (e.g., element 7 of FIG. 1) such as a mouse, a touchscreen, and the like, one or more program elements 51 from the list 50.

According to some embodiments, the selectable program elements 51 of list 50 may be presented to the user, on a screen (e.g., output device 8 of FIG. 1) as high-level, human intelligible text of a programming language.

As shown in sub step 20B, and as elaborated further herein, embodiments of the invention may edit program code 30, for example by inserting the selected one or more program elements 51 into the program code 30. As shown in sub step 20C, embodiments of the invention may subsequently update the displayed program code 30 (e.g., on the user's screen) to reflect the change, thus completing an iteration or a cycle of modifying the program code 30.

It may be appreciated that the workflow described herein (e.g., in relation to FIG. 2) may be based on selection (e.g., by the user) of one or more valid program elements 51 from a list of valid program elements, and may not facilitate or include free modification of the program code 30 by the user (e.g., by typing text). Thus, embodiments of the invention may prevent inclusion of text that is erroneous (e.g., having syntax, grammatical or other errors) in the program code 30.

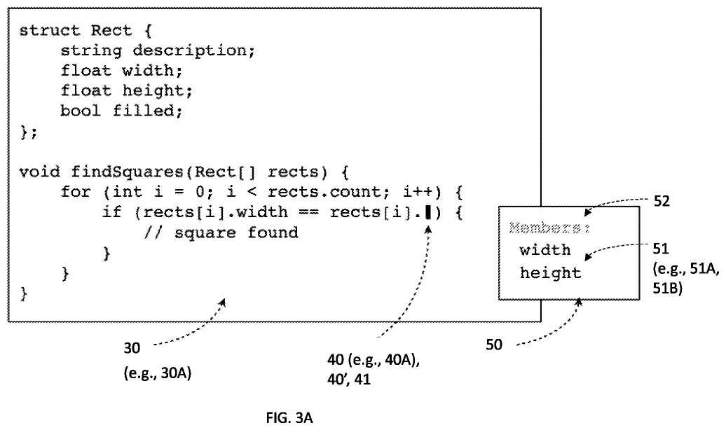

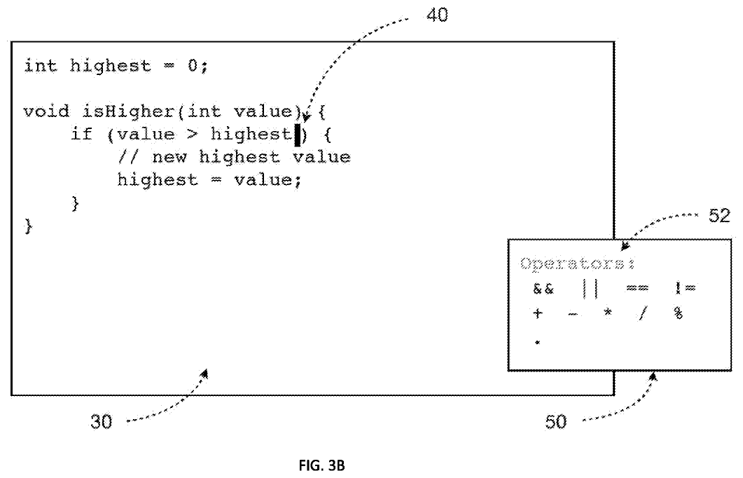

Reference is further made to FIG. 3A, which is a non-limiting example of usage of a method of computer-assisted computer programming according to some embodiments of the invention.

As depicted in the example of FIG. 3A, program code 30 may be displayed to a user on a display device (e.g., element 8 of FIG. 1). The displayed program code 30 may include a current (e.g., at a present point in time) text, representing code of a written program.

Program code 30 may be displayed as non-editable text, in a sense that a user may be prevented from, or not allowed to, directly change program code 30, by bypassing the workflow of step 10 and step 20 of FIG. 2. For example, a user may not be allowed to freely type in text and/or delete text so as to change program code 30.

As depicted in the example of FIG. 3A, the user may have marked a location 40′ in program code 30. For example, the marked location 40′ may refer to a position in program code 30 (e.g., a line number and/or an offset within the line) in which the user has chosen to insert a program element into program code 30.

Embodiments of the invention may obtain an insertion location 40 in the displayed program code, based on marked location 40′. For example, embodiments of the invention may determine, as elaborated herein, whether marked location 40′ is valid for inserting a program element 51 into program code 30; If marked location 40′ is determined as valid, then insertion location 40 may be set as equal to (e.g., same line number and offset) marked location 40′. If marked location 40′ is determined as invalid, then insertion location 40 may be set at the nearest position (e.g., directly following marked location 40′) that is valid for inserting a program element 51 into program code 30.

In the example depicted in FIG. 3A, insertion point 40 is located following the dot (.) operator, commonly referred to as the “member operator”.

It may be appreciated that additional implementations of marked location 40′ and insertion point 40 (e.g., 40A, 40B) may also be possible. In such embodiments, a user may be allowed to mark a location 40′ at any location in the presented program code 30 without discriminating between valid and invalid locations for insertion of code. Subsequently, embodiments of the invention may enable the user to perform different actions according to the marked location.

For example, in a condition that a user marks a location (e.g., produces a marked location 40′) following a program element, embodiments of the invention may produce an insertion point 40, and present a list of suggested program elements 51 that may be valid for insertion at that insertion point 40. In addition to displaying list 50, in a condition that a user marks a location (e.g., produces a marked location 40′) that is at a position of a program element 51 (e.g., in the middle of a symbol name) in the presented program code 30, embodiments of the invention may highlight the marked program element 51, produce an insertion point 40 that relates to the highlighted program element 51, and produce a list 80 of suggested actions 81 that may be applied to the highlighted program element 51, as elaborated herein.

Embodiments of the invention may subsequently produce a list 50 of suggested, selectable valid program elements 51 (e.g., 51A, 51B, etc.) may be displayed to the user.

Program elements 51 (e.g., 51A, 51B, etc.) may be referred to as ‘suggested’ in a sense that they may be displayed or brought to the user's attention by embodiments of the invention. Program elements 51 may be referred to as ‘selectable’ in a sense that one or more of the Program elements may be chosen or selected through interaction with a user (e.g., via a computer mouse). Program elements 51 may be referred to as ‘valid’ in a sense that embodiments of the invention may verify compliance of the relevant program elements in relation to the location of the insertion point (in this example, following the member operator) and/or with one or more rules of the programming language (in this example, a rule of the C++ language, dictating that members of the ‘Rect’ structure would follow the member operator).

In the example of FIG. 3A, the left operand of the member (dot) operator is an element of the ‘rects’ array. The type of the elements of this array is ‘Rect’, as declared in the parameter of the ‘findSquares’ function. Hence the only valid options for the right operand of the dot operator are the members declared in the ‘Rect’ struct. Furthermore, the result of the dot expression is used as the right operand of the equality (==) operator. The left operand of the equality operator is another dot expression, which returns a value of type ‘float’. The equality operator relies on the existence of a method for testing the equality of its two operands. Because such a method does not exist for testing equality between a ‘float’ type value and ‘string’ or ‘bool’ type value, only the members of type ‘float’ are valid and hence appear in the list of suggestions.

In this example, embodiments of the invention may determine, as elaborated herein, that a first valid program element 51 (e.g., 51A) for insertion at the location of the selected insertion point 40 may be ‘width’, and that a second valid program element 51 (e.g., 51B) for insertion at the location of the selected insertion point 40 may be ‘height’. Embodiments may display (e.g., on the user's screen) the list 50 of determined valid program elements 51.

Additionally, embodiments of the invention may present descriptive text 52 corresponding to the list 50 of valid program elements 51. In this example, the descriptive text 52 of a category name (e.g., “Members”) may be presented as a title for the user's convenience.

According to some embodiments, the user may choose or select (e.g., via input device 7 of FIG. 1) at least one program elements 51 of list 50. As elaborated herein, embodiments of the invention may receive the user's selection, and may insert or integrate the chosen program element into program code 30 at the marked insertion location 40. It may be appreciated that if the user marks a different insertion location 40 in program code 30, a new list 50 of program elements may be generated and displayed.

According to some embodiments, embodiments of the invention may insert the selected at least one program elements 51 of list 50 into program code 30, solely based on the user's selection.

The term ‘solely’ may indicate, in this context, that a user may be prevented or prohibited from inserting a program element into the program code in any way that is devoid, or does not include selection of the at least one selectable, program element 51 from the list 50 of selectable, valid program elements. For example, embodiments of the invention may not enable or facilitate insertion of program elements into program code 30 via methods of typing text directly into program code 30, “dragging and dropping” graphical and/or textual representations of program elements into program code 30, “copying and pasting” graphical and/or textual representations of program elements into program code 30, etc.

Reference is now made to FIG. 3B, which is another non-limiting example for using computer-assisted computer programming, according to some embodiments of the invention.

In the example of FIG. 3B, insertion point 40 is located following the ‘highest’ operand. Embodiments of the invention may produce a list 50 of program elements that are valid for insertion into program code 30, at that insertion point 40. In this example, the list of valid program elements includes operators that may be inserted at insertion location 40. It may be appreciated by a person skilled in the art, that the example of FIG. 3B demonstrates assisting a user in selecting operators, so as to produce valid mathematical and logical expressions. Such functionality may not be obtained from currently available systems for computer-assisted programming that may include, for example, an implementation of “code completion”.

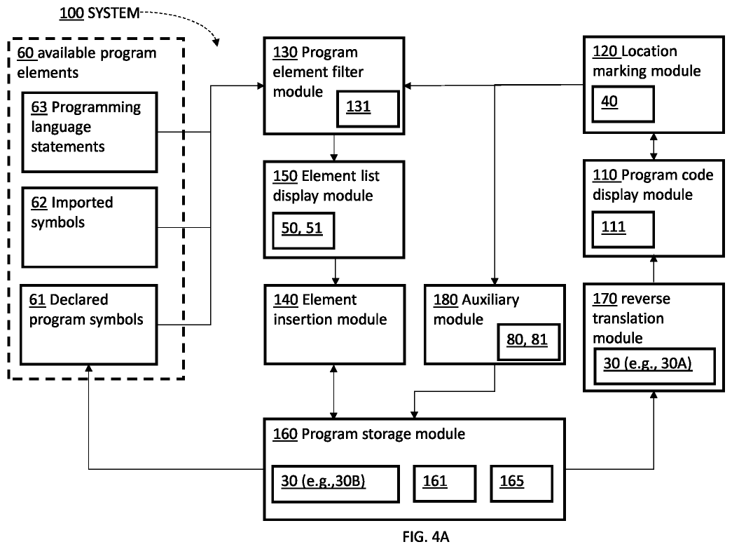

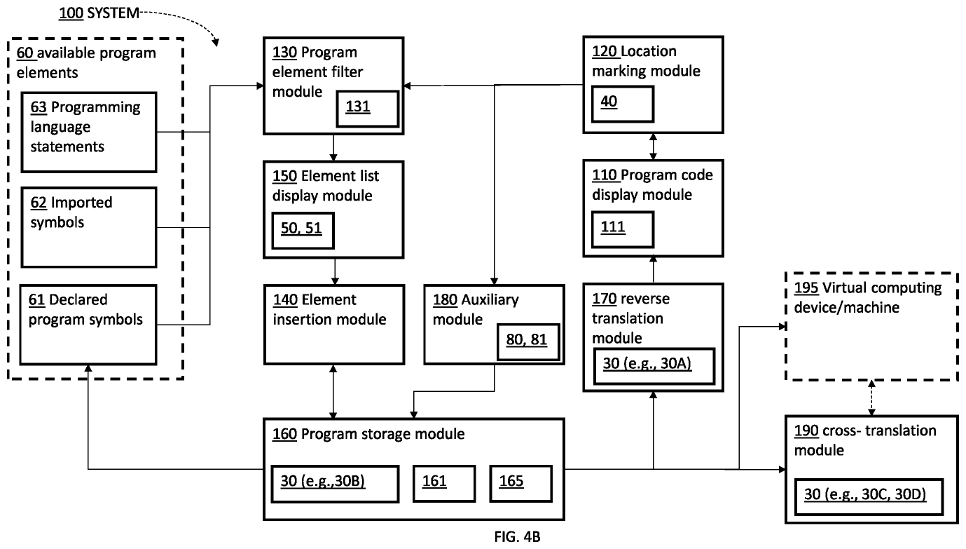

Reference is now made to FIG. 4A, which is a high-level block diagram, depicting a system 100 for computer-assisted computer programming, according to some embodiments of the invention.

According to some embodiments of the invention, system 100 may be implemented as a software module, a hardware module, or any combination thereof. For example, system may be or may include one or more computing devices such as element 1 of FIG. 1, and may be adapted to execute one or more software modules of executable code (e.g., element 5 of FIG. 1) to implement embodiments of methods of the present invention, as described herein.

According to some embodiments, system 100 may include a program code display module 110, adapted to display program code 30 (e.g., element 30 of FIG. 3A, FIG. 3B) comprising zero or more program elements 51 of the written program on a user interface or screen, as non-editable text.

According to some embodiments, program code display module 110 may be adapted to associate one or more program elements 51 (e.g., 51A) with corresponding positions of the one or more program elements 51 in the displayed program code 30, as elaborated herein.

According to some embodiments, and as elaborated herein (e.g., in relation to program storage module 160), embodiments of the invention may maintain or store, on a computer memory device, a first version or representation of program code 30 (e.g., marked 30B) in an intermediary-level or low-level format (e.g., as elaborated herein, in relation to program storage module 160). Embodiments of the invention may translate said version or representation 30B of program code 30 to a second version or representation of program code 30 (e.g., marked 30A), formatted as a human intelligible, high-level programming-language. The high-level version or representation 30A may be presented to the user via program code display module 110.

Accordingly, each location (e.g., insertion location 40) in program 30 may have two aspects. A first aspect of location (e.g., marked 40A) may be a spatial aspect, defining a location (e.g., a line number and an offset within the line) in the high-level program code 30A. A second aspect of location (e.g., of insertion location 40) may be a logical aspect (e.g., marked 40B), corresponding to the location of a program element 51 in the lower level (e.g., intermediary-level) program code 30B.

According to some embodiments, program code display module 110 may maintain a location table 111, which may include, or may be implemented as any type of appropriate data structure, such as a table, a linked list, and the like. Location table 111 may include a plurality of entries, where one or more (e.g., each) entry may associate a specific program element 51 (e.g., variable name, operator, function name, etc.) to one or more specific locations (e.g., one or more line numbers, one or more offsets within line numbers, etc.) in program code 30. Pertaining to the example of FIG. 3A, location table 111 may include at least one entry that may include an association of the member (dot) operator with the location of the ninth line in program code 30 and an offset of thirty (30) characters within that line.

Additionally, or alternatively, location table 111 may include at least one entry that may associate at least one program element 51 (e.g., the member element) in the lower-level (e.g., the intermediary-level) version or representation (e.g., 30B) of program code 30 with at least one location (e.g., a line number and an offset within that line) of that element in the high-level version or representation (e.g., 30A). In other words, location table 111 may associate between one or more (e.g., each) position 40B of program element 51 in program code 30B and a corresponding location 40A in program code 30A. An example of an implementation of location table 111, according to some embodiments of the invention is brought further below, e.g., in relation to Table 2.

Embodiments of the invention may maintain location table 111 based on reverse translation of intermediary-level program code 30B, as elaborated further herein (e.g., in relation to reverse translation module 170). In other words, Reverse translation module 170 may be configured to, during translation of intermediary-level program code 30B to high-level program code 30a, creating or updating location table 111, associating user-marked locations (e.g., 40A) with corresponding program elements 51 in the intermediate-level code format 30B. subsequently, identifying the insertion location 40B as corresponding to the insertion location 40A may be done based on the location table 111.

As elaborated herein, embodiments of the invention may present (e.g., in that “foreground”) program code 30 in a high-level format 30A (e.g., human intelligible, programming language format), and maintain (e.g., in the “background”) the program code 30 in a lower-level (e.g., intermediate-level) format 30B.

According to some embodiments, and as elaborated further herein, system 100 may obtain (e.g., via a user interface, such as input element 7 of FIG. 1), a selection of at least one program element 51 and a corresponding insertion location 40B, for inserting program element 51 into program code 30B (e.g., in the background, intermediate-level representation). System 100 may update the lower-level (e.g., intermediate-level) 30B representation of program code 30, to include the selected at least one textual program element 51 at said insertion location 40B, in the lower-level (e.g., intermediate-level) format. System 100 may translate the lower-level (e.g., intermediate-level) 30B representation of program code 30, to produce an updated representation of program code 30, in the high-level format 30A and may display the updated, high-level representation on the user interface. In other words, system 100 may update the display of program code 30A, based on the program code 30B that may be stored in the computer memory (e.g., element 4 of FIG. 1), to include the at least one inserted program element 51.

According to some embodiments, the intermediary-level representation of program code 30B may be stored on a computer memory (e.g., element 4 of FIG. 1), and may comprise a structured program code model, (e.g., element 165 of FIG. 4A), as elaborated herein (e.g., in relation to Example 1). The program code representation 30A displayed to the user may be in a second format, comprising high-level, human-intelligible text of the programming language.

As elaborated herein, embodiments of the invention may only allow selection of the at least one program element 51 and insertion of the at least one program element 51 at the corresponding insertion location 40B in accordance with predefined programming rules or constraints. Moreover, embodiments of the invention may provide an improvement over currently available systems for computer-assisted programming by presenting, for selection by the user only program elements 51 that are valid for insertion at the corresponding relevant insertion point 40.

According to some embodiments of the invention, system 100 may receive, start from, or relate to a set of rules (e.g., element 131) pertaining to a relevant programming language (e.g., a programming language which may be supported by embodiments of the invention for creating program code 30). The set of rules 131 may, for example be implemented as, or reside within any appropriate data structure such as a table, a database, a linked list, and the like. Alternatively, the set of rules 131 may be included, or incorporated within a module (e.g., a software module) of system 100, such as program element filter module 130. It may be appreciated that for the purpose of clarity, further references to the set of rules will relate to them as a “rule data structure” element 131, however other implementations of the set of rules may also be possible.

According to some embodiments, system 100 may receive, via the user interface (e.g., element 7 of FIG. 1, such as a mouse), a selection of an insertion location 40A in high-level representation 30A of program code 30. System 100 may identify, as elaborated herein (e.g., in relation to location marking module 120) another insertion location 40B, in the lower level (e.g., intermediate-level) representation 30B, that corresponds to the insertion location 40A of the high-level representation 30A.

According to some embodiments, and as elaborated further below, system 100 may identify one or more program elements 51, that are valid for insertion at the insertion location of the first data element, according to the set of rules (e.g., in rules' data structure 131), as elaborated herein (e.g., in relation to program element filter module 130). System 100 may subsequently present, via the user interface, the one or more valid program elements 51 as list of selectable elements, as elaborated herein (e.g., in relation to element list display module 150).

According to some embodiments, and as elaborated further below, system 100 may receive, via the user interface, a selection of at least one program element 51 from the list of selectable program elements, and may insert the selected at least one program element 51 into the lower level (e.g., intermediary-level) representation 30B of program code, as elaborated herein (e.g., in relation to element insertion module 140).

According to some embodiments, system 100 may include a location marking module 120, configured to enable a user to mark at least one location in the presented program code 30A, that may be valid for inserting a new program element.

Location marking module 120 may be configured to receive, from an input device (e.g., element 7 of FIG. 1) such as a mouse, a mark of a spatial location 40′ (e.g., a location on the screen) that may be of interest to the user. Location marking module 120 may produce an insertion indicator 41, that may correspond to marked location 40′. Location marking module 120 may present the insertion indicator 41 (e.g., as a black or blinking rectangle in FIG. 3A) on a computer screen (e.g., via program display module 110), for the user's convenience.

According to some embodiments, following marking (e.g., by a user, via a mouse click) of a location 40′ in the program code 30 text, location marking module 120 may decide or determine whether the marked location 40′ is valid for insertion of a code element 51, based on rules (e.g., in rules data structure 131) of the relevant programming language. Location marking module 120 may display the insertion indicator 41 as part of the program code according to said decision. For example, location marking module 120 may present insertion indicator 41 only if the marked location is valid for insertion of a code element 51.

As elaborated above, table 111 may include one or more entries that may associate a location (e.g., marked location 40′) with corresponding positions 40B of one or more program elements 51 in intermediary-level program code 30B. According to some embodiments, location marking module 120 may be configured to determine whether a position 40B in program code 30B is valid for insertion of a program element 51, in accordance with rules (e.g., in rules data structure 131) of the relevant programming language in use, and present the insertion indicator 41 accordingly (e.g., only if the location 40B is valid for insertion of a code element 51 in program code 30B). It may be appreciated that in a condition in which location marking module 120 determines that location 40B is valid for insertion of a code element 51 in program code 30B, the location of presented insertion indicator 41 may be the same, or converge with higher-level aspect 40A of insertion point 40B. In other words, in such conditions, insertion indicator 41 may graphically represent (e.g., to the user) the high-level aspect 40A of insertion point 40B in program code 30B, where insertion point 40B is valid for insertion of one or more program elements 51.

For example, In a condition that the programming language in use is the ‘C’ language, location marking module 120 may determine that a specific position is valid for code insertion if it is located within a function block (e.g., within the main( ) function block), and the like.

In a condition that the user's interface (e.g., element 7 of FIG. 1) includes an incremental navigation element (for example keyboard arrow keys), location marking module 120 may be adapted to move insertion indicator 41 between valid insertion locations, according to the direction of navigation. For example, a right-arrow key will move the insertion indicator 41 to the next valid insertion location 40A, whereas a left-arrow key will move the insertion indicator 41 to the previous valid insertion location 40A.

In other words, as elaborated above, table 111 may include one or more entries that may associate a location 40 (e.g., insertion location 40A) in the front-end representation 30A of program code 30A with corresponding positions of one or more program elements 51 in the lower-level (e.g., intermediary-level) representation 30B of program code 30. In a condition that a user uses incremental navigation (e.g., presses a right-arrow key), location marking module 120 may search for a proximate (e.g., the next) position 40B in intermediary-level program code 30B that may be valid for insertion of a code element 51.

According to some embodiments, location marking module 120 may produce an insertion point 40 (e.g., 40A) that may include data pertaining to the user's marked location 40′ in the program code 30 (e.g., 30A). Such data may include, for example, a line and/or an offset within a line of program code 30 that corresponds to the spatial location marked by the user.

Location marking module 120 may subsequently collaborate with location table 111 of program code display module 110, to associate or correlate marked location 41 (e.g., insertion location 40A) with one or more respective program elements 51. Pertaining to the example of FIG. 3A, in a condition that a user marks, on the screen (e.g., by a mouse click) the spatial position 41 following the member (dot) operator, location marking module 120 may identify the marked position 41 as insertion point 40A, and may collaborate with location table 111 to associate the position 40A in program code 30A, following the member (dot) operator, with insertion point 40B.

As elaborated herein (e.g., in relation to FIG. 3A), embodiments of the invention may subsequently suggest valid program elements 51 (e.g., 51A, 51B such as ‘width’ and ‘height’) for selection, based on rules (e.g., in rules data structure 131) such as syntactic rules of the relevant programming language of program code 30, in view of the identified insertion point 40 (e.g., 40B, directly following the member operator).

As elaborated herein (e.g., in relation to auxiliary module 180), embodiments of the invention may further utilize the determination of insertion point 40 (e.g., 40B) to perform one or more editing actions on program code 30 (e.g., on intermediary-level code 30B), including for example, editing of one or more values pertaining to at least one program element 51 in program code 30B; editing of one or more symbols pertaining to at least one program element 51 in program code 30B; copying of at least one program element 51 of program code 30B; deleting of at least one program element 51 of program code 30B, and the like.

According to some embodiments, system 100 may include a program element filter module 130. As elaborated herein, program element filter module 130 may be adapted to receive a plurality of available program elements 60 that may be used in program code 30, receive insertion point 40 (e.g., 40B, from location marking module 120), and subsequently extract or filter from the plurality of available program elements 60 only those that are valid for insertion at insertion location 40 (e.g., 40B), based on the rules of rules' data structure 131 of the relevant programming language.

For example, program element filter module 130 may be configured to (a) scan, or traverse over the plurality of available program elements 60; (b) for one or more (e.g., each) program element of the plurality of available program elements 60, scan or traverse over the rules of rules' data structure 131; and (c) determine whether the relevant program element complies with said rules, and is therefore valid for insertion into program code 30 at the location of insertion point 40. It may be appreciated that the example above, in which all the rules and all the available program elements 60 are scanned may be naive, and specific modifications to the process in the above process may be implemented for a more efficient implementation.

According to some embodiments, program code 30B may be stored, as elaborated herein (e.g., in relation to program storage module 160) in a structured program code model, that may be arranged in a hierarchical structure (e.g., a tree structure), so as to maintain a structure (e.g., a hierarchical structure) of the program code 30 (e.g., 30B). Thus, program element filter module 130 may collaborate with program storage module 160, so as to extract or filter from the plurality of available program elements 60 only those that are valid for insertion at insertion location 40 according to the structured program code model (e.g., according to the structure of the written program).

According to some embodiments, the available program elements 60 may be derived from a dynamic database 60, and may include a list 61 of symbols that may be declared (e.g., by a user) in program code 30, a list 62 of symbols that may be imported from external sources, including for example APIs, imported software libraries and the like, and a list 63 of static statements that may pertain to, or be defined by the relevant programming language. Embodiments may include additional types of available program elements 60. The database may be ‘dynamic’ in a sense that: (a) the list of imported symbols 62 may be created and/or updated whenever an external API/library is imported, removed and/or changed; and (b) the list of symbols 61 declared in the written program may be altered or updated each time an element (e.g., a symbol declaration) is deleted from, or inserted or changed in program code 30.

According to some embodiments of the invention, system 100 may include an elements list display component 150 that may be adapted to receive the available program elements 60 that have been filtered or extracted by program element filter module 130, and display the filtered elements 60 (e.g., on a computer screen) as a list 50 of valid, selectable program elements 51. According to some embodiments of the invention elements list display component 150 may be configured to accumulate one or more (e.g., a plurality) of program elements 51 that are valid for insertion at the relevant insertion point 40 in a list. elements list display component 150 may sort the list of program elements according to the at least one category of the program elements 51 (e.g., the program elements 51 types) and/or according to at least one preference of the user. elements list display component 150 may present list 50 as a selectable list of elements.

Elements list display component 150 may receive, via an input device (e.g., element 7 of FIG. 1) such as a computer mouse, an indication of a user's selection (e.g., a mouse-click) of one or more specific program elements 51, for insertion at the location of insertion point 40.

According to some embodiments, following creation of insertion point 40 in program code 30, elements list display component 150 may be configured to display one or more (e.g., all) the valid program elements 51 produced by the program element module 130. In some embodiments, the presented program elements 51 may be displayed as a single list or collection. Additionally, or alternatively, the presented program elements 51 may be divided into categories, and may be selected in two steps: e.g., a first step for selecting a category and a second step for selecting a program element 51. Examples for categories of program elements 51 may include for example, declarations (e.g., variable names), flow-control statements (e.g., ‘if’, ‘else’, etc.), operators (e.g., arithmetic operators, logical operators, etc.), functions, values, and the like.

According to some embodiments, elements list display module 150 may produce list 50 as a sorted list according to a preselected criterion. For example, program elements 51 of list 50 may be sorted based on alphabetical order, based on frequency of use, and/or based on any other appropriate sorting criterion.

According to some embodiments, program code 30B may be stored as a structured object code model 165, and code model 165 may maintain the logical structure of program code 30B at any time, as elaborated herein (e.g., in relation to program structure module 160). According to some embodiments, elements list display module 150 may utilize the maintained logical structure of code model 165, to enable additional advantageous methods of sorting list 50.

For example, in some embodiments, elements list display component 150 may sort available symbols (e.g., variables and/or functions of program code 30) in list 50, according to structured object model 165 of code 30B, by a criterion of symbol scope or proximity. In other words, elements list display component 150 may display symbols that may be defined in the local scope (e.g., within the same file, within the same function, within the same code block, within the same method, and the like) before or above symbols that are defined beyond the local scope (e.g., in another file, in another function, in another block, etc.).

According to some embodiments, elements list display module 150 may enable a user to control, select or define (e.g., via input device 7 of FIG. 1) which sorting method(s) and/or sorting criteria to use.

According to some embodiments, elements list display module 150 may display a predefined scope of data pertaining to each presented program element 51 in list 50. For example, elements list display module 150 may be configured to display (e.g., on the user's computer screen) only names or symbols of suggested program elements 51. However, it may be appreciated that element list display module 150 may nevertheless retain the information needed in order to insert or integrate each of elements 51 into program code 30. This information may include, for example, a type of program element 51 and data pertaining to the precise location in the programs code 30 hierarchy where the element is to be inserted.

Pertaining to the example depicted in FIG. 3A, program element 51B (e.g., represented by the symbol name “height”) may include (e.g., in addition to the explicitly presented symbol name, “height”) an implicit (e.g., not presented) association or relation to a corresponding program element (e.g., relation to the dot (.) operand). In this example, program element 51B may include an indication that the ‘height’ program element 51 should be placed following (e.g., as the right side operand of) a program element (e.g., the dot (.) operator) having a specific identification (e.g., a program element serial number), and/or within a specific program block having a specific identification (e.g., a program block serial number). In other words, the data included in program element 51 may include information that is analogous to an address on a postal envelope, indicating where the program element 51 should be inserted in the code model 165 of program code 30B, once selected by the user.

In another example, a first program element 51 may include information that may pertain to a reference to another, second program element 51. For example, as known in the art, a reference to an element in a program may be used to access a variable, call a function, initialize an object of a specific type, break out of a loop, and the like. According to some embodiments, elements list display component may include, in first program element 51 at least one data element that is a reference to a second program element 51 in program code 30B. Such reference data elements may include, for example a link, a pointer to a location in a computer memory, an index, and the like, depending on the specific architecture of the intermediate-level language and/or the implementation or structure of code model 165.

According to some embodiments, in addition to the program elements 51 extracted by the program element filter module 130, elements list display module 150 may suggest one or more descriptive or decorative program elements 51 to the user. Such elements may include, for example, comments, empty lines, and the like. In some embodiments, such elements 51 may appear separately from program element categories, as elaborated above. Additionally, such descriptive or decorative elements may be added or inserted at a location that is separate from an active section of program code 30 (e.g., at the end of one or more code lines, at the end of a file, etc.).

According to some embodiments, and as elaborated further herein, system 100 may include an element insertion module 140 and a program storage module 160. Element insertion module 140 may be adapted to insert one or more program elements 51 into the lower-level (e.g., intermediate-level) representation 30B or version of program code 30, according to the selected valid program element 51. Program storage module 160 may receive at least a portion (e.g., an addition or incrementation) of program code 30, including the inserted one or more program elements 51, and may store program code 30 in a structured object model 165, representing program code 30B. According to some embodiments, following a change (e.g., insertion of a program element) in the program code (e.g., in structured object model 165 of intermediary-level program code 30B), system 100 may identify the change in the stored program code 30B and may translate, as elaborated herein (e.g., in relation to reverse translation module) at least one portion of stored program code 30B, comprising said change, from the first lower-level (e.g., intermediate level) format into the high-level format of the user-intelligible program code representation 30A.

According to some embodiments, structured object model 30B may for example, be or include a representation or description of program code 30 in an hierarchical data structure (e.g., herein referred to as code model 165) that may maintain the hierarchy and/or structure of program code 30 in the intermediary-level format, as demonstrated by the following, non-limiting example, Example 1.

### EXAMPLE 1

### Front-End, High-Level, User Intelligible Programming Language Representation 30A:

```
int max(int a, int b) {
  if (a > b) {
    return a;
  }
  return b;
}
```

Back-End, Structured Program Code Model 165 of Intermediary-Level Representation 30B:

```
“function”: {
  “element_id”: 4081,
  “symbol”: “max”,
  “return_type”: {
    “reference_id”: 618
  },
  “params”: [
    “param”: {
      “element_id”: 4082,
      “symbol”: “a”,
      “type”: {
        “reference_id”: 618
      }
    },
    “param”: {
      “element_id”: 4083,
      “symbol”: “b”,
      “type”: {
        “reference_id”: 618
      }
    }
  ],
  “body”: {
    “element_id”: 4084,
      “elements”: [
      “if”: {
        “element_id”: 4085,
        “condition”: {
          “binary_operator”: {
            “reference_id”: 729
            “left_value”: {
              “get”: {
                “reference_id”: 4082
              }
            },
            “right_value”: {
              “get”: {
                “reference_id”: 4082
              }
            }
          }
        },
        “then”: {
          “element_id”: 4086,
          “elements”: [
            “return”: {
              “element_id”: 4084,
              “reference_id”: 4081
              “value”: {
                “get”: {
                  “reference_id”: 4082
                }
              }
            }
          ]
        }
      },
      “return”: {
        “element_id”: 4087,
        “reference_id”: 4081,
        “value”: {
          “get”: {
            “reference_id”: 4083
          }
        }
      }
    ]
  }
}
```

The first part of Example 1 includes a definition of a ‘max’ function in the ‘C’ programming language. The function max is configured to receive two integer parameters, and return the maximal value between them, as may be appreciated by a person skilled in the art. The second part of Example 1 includes a non-limiting, implementation of the hierarchical structured program code model 165, which may correspond to the ‘C’ language definition of the ‘max’ function, and may represent the ‘max’ function in an intermediary-level format, according to some embodiments of the invention.

As shown in Example 1, intermediate-level program code 30B may be structured as a hierarchical structured program code model 165, representing a hierarchical structure of the program code 30. The front-end, user-level (or user intelligible) representation 30A and the back-end, structured code model 165 of intermediary-level representation 30B of the ‘max’ function program code 30 in the ‘C’ programming language may include representations of the same program elements. These program elements include, for example declaration of a function referred by the ‘max’ symbol, a body of the ‘max’ function, a first parameter (a), a second parameter (b), an ‘if’ statement, a binary operator (e.g., ‘>’), an ‘else’ statement, a ‘return’ statement, etc.

According to some embodiments, and as seen in Example 1, the hierarchical structured program code model 165 may allow system 100 to easily determine a context (e.g., a location) of at least one program element 51 in program code 30, according to the location of the at least one program element 51 in hierarchical structured program code model 165. In a similar manner, the hierarchical structured program code model 165 may allow system 100 to easily determine a scope of one or more symbols of program elements 51 in the program code 30 according to the hierarchical structured program code model 165.

As shown in Example 1, the hierarchical structured program code model 165 may include, for each first program element 51 of the program code, which refers a second program element 51 of the program code, a reference to the second program element, allowing easy access to the second program element via said reference. For example, as also seen in Example 1, program elements 51 of program code 30B may be associated with reference numbers or identifications (e.g., ID numbers). For example, the return type of the ‘max’ function and the input parameters a and b may be identified by reference number 618 (which may be defined elsewhere as pertaining to the integer type). In another example, the first parameter (a) may be referenced by a first ID number (4082), and the second parameter (b) may be referenced by a second ID number (4083), allowing the ‘max’ function to return either one of these referenced parameters.

As also seen in Example 1, program elements 51 of program code 30B may be represented in the program code model 165 of the intermediary-level 30B representation of the ‘max’ function in a hierarchical manner The term ‘hierarchical’ may indicate, in this context, that one or more first program elements 51 of program code 30B may include or refer to one or more second program elements 51 of program code 30B. This hierarchy may be viewed in the textual example of Example 1 in the indentation of the programming lines. For example, the ‘function’ program element 51 (e.g., program element ID 4081) may include the ‘param’ program block of ‘a’ (e.g., program element ID 4082), the ‘param’ program block of ‘b’ (e.g., program element ID 4083), and the ‘body’ program block (e.g., program element ID 4084). The program element that is the ‘body’ program block may in turn include program elements such as the ‘if’ statement block (e.g., program element ID 4085), the ‘then’ statement block (e.g., program element ID 4086) and the ‘return’ statement block (e.g., program element ID 4087), etc.

Embodiments of system 100 may include a reverse translation module 170, adapted to translate structured object model 30B to high-level text 30A. In other words, reverse translation module 170 may produce, from an intermediary-level format 30B of program code 30 a high-level programming language representation 30A of program code 30, that may be human-intelligible, and may be displayed (e.g., on a computer screen) by program code display module 110.

As known to persons skilled in the art, currently available programming systems normally store code written by programmers as human-intelligible text, which is commonly referred to as a “source code”. This source code is normally used as input for a compiler. Some currently available programming systems may include two or more compilers. For example, a first compiler may be referred to as a “front-end” compiler, and a second compiler may be referred to as a “back-end” compiler. The front-end compiler is normally configured to translate the source code, written in a high-level programming language, into an intermediate-level language. The back-end compiler is normally configured to translate the code of intermediate-level language format into a low-level language format, commonly referred to as “machine code” language, for execution.

A source code element (e.g., a high-level representation of programming code) typically abides to strict syntax rules and elaborate formal structures, but nevertheless may be very expressive and flexible. The front-end compiler is typically configured to parse the source code, verify its syntax, analyze its structure, and reduce it into an intermediate level-language, which typically contains only simple, imperative statements. If the front-end compiler fails to parse the syntax of the source code, for example—in a condition that the source code structure is in violation with any of the rules of the programming language, the front-end compiler may produce an error notification.

According to some embodiments of the present invention, and in contrast to currently available systems for programming (e.g., as elaborated above), element insertion module 140 may be configured to create program code 30 directly in an intermediate-level language representation (marked 30B), as elaborated further herein. Accordingly, program storage module 160 may be configured to store program code 30 directly in an intermediate-level language representation (marked 30B). The term “directly” may be used in this context to indicate that the intermediate-level representation 30B of program code 30 may not be created as a product (e.g., via compilation) of a high level, source code representation (e.g., 30A) of program code 30, but rather directly via insertion of program elements 51 in the intermediate-level format 30B, into the structured program code model 165 of program code 30.

The textual representation of the program code 30 in a high-level language format 30A may be generated on demand (e.g., by reverse translation module 170) from the intermediate-level representation 30B, and may not need to be stored, parsed, or analyzed. According to some embodiments, high-level language format 30A may have the same appearance or format as high-level code that may be used as “source code” in currently available programming systems. It may be appreciated that as the process of the present invention may not require compilation of high-level language format 30A (e.g., as done with a source code by currently available systems), it may be devoid of compilation errors altogether.

As known to persons skilled in the art, in currently available systems for programming, the intermediate-level language typically contains only information that is required for executing the program. For example, an intermediate-level program code element may not retain symbol names or comments.

In contrast, according to some embodiments of the present invention, code model 165 of the intermediary-level program code may retain all the information that may be required to translate (e.g., by reverse translation module 170) the intermediate-level language representation 30B to a high-level language representation 30A of program code 30, without losing any information. In addition, since most high-level languages have a hierarchical structure (e.g., as demonstrated in relation to Example 1), embodiments of the invention may maintain that hierarchical structure within the code model 165 of the intermediate-level language representation 30B of program code 30. This can be implemented by storing references (e.g., links and/or pointers, such as the reference IDs in Example 1) between individual program elements 51 and their container (e.g., ‘parent’) program elements 51. For example, as elaborated herein (e.g., in relation to Example 1), code model 165 may be formed as an object tree, where a first program element 51 (e.g., a function call) may contain (e.g., be a parent of) one or more second program elements 51 (e.g., parameter blocks), which may contain (e.g., be a parent of) one or more third program elements 51 (e.g., expression blocks), which may contain one or more fourth program elements 51 (e.g., operators and/or operands), etc.

As elaborated herein, program storage module 160 may be configured to store program code 30 as a structured model 30B, using an intermediate-level language. In order to display the program to the user, reverse translation module 170 may reverse-translate structured model 30B into a human-intelligible, high-level textual programming language format.

According to some embodiments, one or more (e.g., each) program element 51 stored in program code 30B may include all the information needed for translating it to a high-level textual program language format 30A. Such information may include, for example, incorporation of, and/or reference to, any sub-elements that may be needed by the program element 51. According to some embodiments of the invention, the process of reverse-translation (which may be referred to in the art as de-compilation), may be regarded as straightforward, in a sense that this translation may follow pre-established coding templates that may pertain to the relevant programming language.

For example, in order to produce a textual representation 30A of a program element 51 such as a ‘while’ loop statement, reverse translation module 170 may use a template such as in the following example, Example 2:

### EXAMPLE 2

<color=keyword>while</color>(<var>condition</var>) {<var>body</var>} where ‘condition’ may include a textual representation of the loop's condition element, and ‘body’ may include a block of executable statements.

The textual representation of program elements 51 inside a high-level code block 30A may be determined specifically according to the relevant programming language. For example, the textual representations of program elements 51 may appear in separate lines, may be indented, may be followed by semicolons, etc., according to the syntax, or the pre-established coding templates of the relevant programming language (e.g., Java, C#, Python, etc.).

Pertaining to the example of the ‘while’ loop, in some languages (e.g., C), curly brackets may only be required when the body block contains more than one statement, whereas in other languages curly brackets may not be required at all, or may be required for body blocks that contain only one statement. Reverse translation module 170 may be configured to use a template (e.g., as in Example 2) that may comply with the specific grammar and/or syntax of the relevant programming language, so as to correctly include curly brackets in code 30A. In this manner, reverse translation module 170 may translate one or more (e.g., each) element 51 of program code 30B into textual representation, by using templates corresponding to the relevant program language.

As elaborated herein, program code 30 may include one or more program elements 51 that may include a hierarchy of sub-elements 51. For example, a first program element 51 (e.g., a first ‘for’ loop) may include one or more sub-elements 51 (e.g., one or more embedded, second ‘for’ loops). In such conditions, reverse translation module 170 may start with a top-hierarchy element (e.g., the outermost loop) and recursively traverse over the structured code model 165, so as to create a high-level representation 30A that may include the high-level textual representation of each program element 51, and the high-level textual representation of the corresponding sub-elements 51 therein.

According to some embodiments, reverse translation module 170 may generate a textual representation for each program element 51 and may keep an entry or a record of a range of characters containing each element in location table 111 of program code display module 110. This record of table 111 may enable location marking module 120 to correlate between a marked text location 40′ (and/or a subsequent insertion point 40A) and specific program elements 51 of program code 30B.

In other words: (a) the structured code model 165 may include information pertaining to each program element 51, and its respective identification (e.g., program element ID number) within a specific location (e.g., within a specific program block) in the hierarchical program structure; and (b) the textual presentation 30A of program code includes location of high-level program elements program code in corresponding spatial locations (e.g., line number and offset). Therefore, reverse translation module 170 may fill or maintain table 111 by the process of reverse translation of program code 30B into the high-level presentation 30A.

According to some embodiments, location table 111 may be implemented as, or may include a table such as the non-limiting example of Table 2, below. The example of Table 2 pertains to an implementation of location table 111, that corresponds to the following single-line portion of program code 30A:

print(a, a>b).

TABLE 2

| Program element | Start | End |
|---|---|---|
| reference | offset | offset |
| call print | 0 | 15 |
| list | 6 | 14 |
| get a | 6 | 7 |
| operator | 9 | 14 |
| get a | 9 | 10 |
| call >(int, int) | 11 | 12 |
| get b | 13 | 14 |

As shown in the example of Table 2, at least one (e.g., each) entry (e.g., row) in location table 111 may include a reference to a program element 51 in program code 30B, and a range of offsets in the displayed code 30A where the element is represented. Thus, table 111 may associate at least one program element of program code 30B with a corresponding location in the displayed, high-level code 30A. Likewise, embodiments of the invention (e.g., reverse translation module 170) may utilize table 111 to translate or associate between a location (e.g., insertion location 40B) in the background, intermediary-level program code representation 30B and a corresponding location (e.g., insertion location 40A) in the foreground, high-level program code representation 30A.

For example, in a condition that a user marks an insertion location 40 at offset 14 in the displayed text (e.g., between the character ‘b’ and the character ‘)’). In this condition, Display module 110 may transfer the text offset 14 to location module 120. Location module 120 may scan location table 111 for elements that begin or end at offset 14. In the above example location module 120 may find 3 matches: (i) The end of the parameter list inside the print call; (ii) The end of the operator expression inside the parameter list; and (iii) The end of the value recall (b) inside the operator expression.

These results may be sent to program element filter module 130, which may scan the database of available elements 60 for elements 51 that may be valid for insertion according to each of the results. For the parameter list (i), program element filter module 130 may find (in language statements 63) an element for adding another parameter to the list. This element may be symbolized as a comma (,) in list 50. For the operator expression (ii), which is known to return a Boolean value, it may find (in SDK symbols 62) some operators that accept a Boolean value as their left operand. Such operators may include &&, ∥, == and !=. For the recall of value b (iii), which in this example is of the integer type, it may find (in SDK symbols 62) some operators that accept an integer value as their left operand. Such operators may include for example +, −, *, / and %.

It may be appreciated that in some languages (e.g., Java) the integer type may be defined as a class, and may have accessible members. In such case, program element filter module 130 may also include in list 50 the member access operator, which may be symbolized as a dot (.).

It may be appreciated that an insertion point 40 (e.g., 40A, 40B) may appear before, after or between existing program elements 51. However, since program elements 51 may contain other (e.g., embedded) program elements 51, a specific location of an insertion point 40A can match the starting or ending offset of more than one program element 51.

For example, as depicted in the example of FIG. 3B, the insertion point 40A matches the ending offset of the operation element “value>highest”, as well as the ending offset of the operand element “highest”

Therefore, according to some embodiments, location marking module 120 may transfer to program element filter module 130 each of the relevant program elements 51, so as to enable program element filter module 130 to suggest one or more (e.g., all) program elements 51 that may be valid for insertion at insertion position 40A, regardless of where in the structured code model 165 of program code 30B the selected program elements 51 will eventually be inserted.

According to some embodiments, a user may mark a spatial location of a displayed program code 30A inside an element (for example between the letters of the ‘while’ statement). In this condition location marking module 120 may mark or highlight the entire program element 51. For example, insertion indicator 41 may span across the entire word ‘while’. Subsequently, elements list display module 150 may produce, and display a list 50 of selectable, valid program elements 51 that may include all available elements that may be valid for replacing the highlighted element (e.g., replace the ‘while’ loop by a ‘for’ loop).

In another example, in the expression “a+b”, the plus (+) operator can be replaced by any other operator that can accept “a” and “b” as its operands. Pertaining to the same example, any of the two operands (e.g., “a” and “b”), if highlighted, may be replaced by any available value, expression, function or variable that is configured to return a value that is acceptable by the plus (+) operator.

According to some embodiments, system 100 may include an auxiliary module 180, adapted to suggest (e.g., to a user), one or more optional actions pertaining to program elements 51 of program code 30. For example, As known in the art, a user may use an input device such as a computer mouse to present a contextual menu on their computer screen (e.g., by performing a mouse right-click). In some embodiments of the invention, a user may highlight a program element 51, and perform a mouse right-click to present (e.g., on a computer screen) a list 80 of one or more optional actions 81. List 80 may be, for example presented as a contextual (e.g., a “pop-up”) menu, and optional actions 81 may be suggested for selection via the contextual menu.

According to some embodiments, when a program element 51 is highlighted, auxiliary module 180 may suggest (e.g., via a contextual menu) relevant editing actions 81 that may pertain to the highlighted program element 51. Examples for suggested editing actions may include: deleting of a program element 51, cutting, copying, and/or pasting of the highlighted program element 51, and the like. Methods of implementing such editing actions are further elaborated below.

The term ‘contextual’ may indicate herein that list 80 may be produced and/or presented differently, depending on the location of the corresponding insertion point 40. For example, in a first condition, insertion point 40 may relate to a first program element 51, and list 80 may include one or action 81 that may be valid for application at insertion point 40.

As elaborated herein (e.g., in relation to Example 1, above) the structured code model 165 of intermediary-level program code 30B may include data pertaining to, or describing a type of one or more program elements 51. Therefore, according to some embodiments, auxiliary module 180 may be adapted to suggest element-specific actions that may correspond to the program element's 51 type.

For example, auxiliary module 180 may be adapted to suggest actions such as: providing help (e.g., by presenting documentation) for the specific highlighted program element 51 and/or program element 51 type, modifying a value (e.g., a value of a number, a string or a field) in the highlighted program element 51, renaming a declared symbol (e.g., a variable, a function, a type and the like), showing (e.g., “jumping to”) a location of a declaration of a symbol when highlighting a reference to it (e.g., an instantiation, a function call and the like), etc.

As elaborated herein, program element filtering module 130 may be configured to receive an insertion point 40 from location marking module 120 and suggest or offer to the user one or more valid program elements 51 for selection. This suggestion may be presented as a filtered list 50 of suggested, selectable valid program elements 51.

According to some embodiments, list 50 may include only program elements 51 that are valid for insertion at insertion point 40, and may be devoid of program elements 51 that are invalid for insertion at insertion point 40. Program element filtering module 130 may produce filtered list 50 by scanning one or more (e.g., all) available program elements 60, and subsequently check or verify each element 60, to determine the element's validity for insertion at the insertion point 40. As elaborated herein, program element filtering module 130 may transfer the list 50 of valid program elements 51 to element list display module 150 for selection by the user.

It may be appreciated by a person skilled in the art that embodiments of the invention may include an improvement over currently available systems for computer-assisted programming, by traversing the entire list of available program elements 60 (e.g., 61, 62 and 63, as elaborated below), and identifying all program elements of list 60 that may be valid for insertion at the corresponding insertion point. This is in contrast with currently available systems that employ “code completion” techniques, which are typically limited to completion of symbols (e.g., variable names) or statements (e.g., instructions) following initial typing (e.g., of a few first characters) by the user.

According to some embodiments, there may be one or more types of sources of program elements 60 (marked 61, 62 and 63 in FIG. 4A) that may be fed into program element filter module 130.

One such type (e.g., 63) of program elements 60 may be of static, predefined statements or instructions that may be provided by the programming language. This first type may include, for example program language statements 63 such as ‘if’, ‘return’, ‘class’, etc.

Another such type (e.g., 61) of program elements 60 may be dynamic, in a sense that it may include program elements 60 that are relevant to a specific program, and may include, for example, symbols and/or names 61 that may be declared in program code 30. This second type may include for example symbols such as variable names, function names, operators, types, etc. According to some embodiments of the invention, program storage module 160 may be configured to update, in real time or near-real time, the list of available declared symbols and/or names 61. The term real-time may be used in this context to indicate that the list of available program elements 60 may be updated after a user may have inserted or declared the relevant symbol, and before filter module 130 may scan list 60 again

Such type (e.g., 62) of program elements 60 may include, for example, symbols that may be imported from external sources such as libraries, SDKs, system APIs, and the like. Embodiments of the invention may include additional types of program elements 60.

According to some embodiments, program element filter module 130 may include, or may be communicatively connected to, programming rule data structure (e.g., a database) 131. Programming rule data structure 131 may be adapted to maintain a set of programming rules or restrictions that may be applicable to one or more specific programming languages. For example, programming rule data structure 131 may include one or more data structures or tables that may be adapted to associate specific types of program elements with corresponding restrictions, pertinent to a relevant programming language.

For example, as known in the art, the standard ‘C’ programming language dictates that an ‘if’ instruction should be followed by a conditional expression and a program block. Hence, a corresponding programming rule, relating to the C language, may be implemented as an entry in a table in programming rule data structure 131. At least one entry of the data structure 131 may associate a first type of a program element 51 (e.g., an instruction program element 51 such as the ‘if’ instruction) with one or more second program elements 51 (e.g., a conditional expression and a program block) that must (e.g., according to the programming language rules) directly follow the first program element 51.

In another example, as known in the art, the standard ‘C’ programming language dictates that a ‘continue’ statement may only appear within a loop (e.g., a ‘for’ loop) block. Hence, a corresponding programming rule, relating to the C language, may be implemented as an entry (e.g., in a table) in programming rule data structure 131, that may associate a first type of a program element 51 (e.g., the ‘continue’ instruction) with a second type of program elements 51 (e.g., a loop program block) where the first program element 51 must reside.

According to some embodiments, program element filter module 130 may collaborate with programming rule data structure 131 to identify the valid program elements 51 that may be suggested for insertion. Pertaining to the ‘if’ instruction example, in a condition that insertion point 40 is located after the ‘if’ instruction, program element filter module 130 may determine, based on the restriction of programming rule data structure 131, that the valid program element 51 for suggestion is a conditional expression. As elaborated further herein, embodiments of the invention may subsequently insert a placeholder program element 51 into program code 30, and may prompt the user to further select program elements 51 (e.g., expressions, program symbols, etc.) to populate the placeholder program element 51, to produce therefrom a program element 51 that is a viable conditional expression.

Additionally, or alternatively, program element filter module 130 may collaborate with programming rule data structure 131 to check the constraints of each available program element 60, and to determine whether each element 60 may be inserted into program code 30 at the relevant insertion point 40.

For example, as known in the art, programming language syntax may impose restrictions or rules pertaining to the hierarchical structure of the program code. For example, flow-control statements (e.g., condition statements, loop statements, etc.) may be restricted to only appear in an execution block, such as a body block of a function, or embedded within another flow-control statement. Program element filter module 130 may thus include a flow-control statement as a valid, selectable program element 51 of list 50 only if the insertion point 40 corresponds to the appropriate restriction in programming rule data structure 131 (e.g., only if insertion point 40 is located within an execution block or another flow-control statement)

In another example, as known in the art, some flow-control statements may have specific contextual constraints. For example program elements such as ‘continue’ statements may only appear inside loops, and program elements such as ‘else’ statements may only appear immediately after the body of an ‘if’ statement. Therefore, program element filter module 130 may thus include a flow-control statement (e.g., ‘else’ or ‘continue’, etc.) as a valid, selectable program element 51 of list 50 only if insertion point 40 corresponds to the appropriate restriction in programming rule data structure 131 (e.g., immediately after the body of an ‘if’ statement, or inside loops, respectively).

In another example, as known in the art, some statements may impose restrictions on their sub-elements. For example, program element 51 such as a ‘for’ statement may include an assignment operator (=), and the assignment operator may dictate that its left operand should be mutable (e.g., a reference to a variable or an expression whose value may be assigned or modified at run-time). Therefore, in a condition that insertion point 40 is at the left side of an assignment operator, program element filter module 130 may thus only include symbols that represent mutable program elements as a valid, selectable program element 51 of list 50.

In another example, program element filter module 130 may collaborate with programming rule data structure 131 to check program language restrictions or requirements pertaining to program element 51 value types. For example, in many languages, condition statements such as ‘if’ and ‘while’ may require as input an expression that returns a Boolean value. Therefore, in a condition that insertion point 40 is located at the location of the input expression, program element filter module 130 may only include program elements that are Boolean expressions or symbols as valid, selectable program element 51 of list 50.

In another example, as known in the art, many programming languages dictate that an index of an array data structure (e.g., in the form ‘array[index]’) would have an integer value. Therefore, in a condition that insertion point 40 is located at the location of the index expression, program element filter module 130 may only include program elements that are integer expressions or symbols as valid, selectable program element 51 of list 50.

As known in the art, strong-typed languages (e.g., C#, Java) are programming languages that dictate that each declared variable or parameter must have a type associated with it. In contrast, weak-typed languages (e.g., JavaScript, Python) allow any variable to receive any type of value. It may be appreciated by a person skilled in the art that embodiments of the invention may be particularly beneficial for strong-typed languages, such as C#, Java and the like; Alongside benefits such as code safety and readability, the production of strong-typed program code 30 by embodiments of the present invention may also provide the benefits of type checking at build-time, and prevention of run-time errors.

In contrast to currently available systems for programming, where type checking is done by a compiler, embodiments of the invention may include type checking by program element filter module 130, before program elements 60 may be inserted into list 50. Thus, filtering elements by value type may dramatically reduce the list 50 of valid program elements 51 (e.g., from the plurality of available program elements 60), and may help a user to easily choose a correct program element for insertion.

For example, as known in the art, in a condition that the programming language is a strong-typed language, a declaration of a program element 51 includes association of the declared program element to a specific type (e.g., a string, an integer, etc.). According to some embodiments, program element filter module 130 may utilize the strong-type property of the programming language to only suggest, and allow insertion of values or expressions based on their types. For example, program element filter module 130 may only suggest, and allow insertion of declared program elements 61 that have a type that is compatible with, or valid in the insertion location.

It may be appreciated by a person skilled in the art that the filtering of program elements 60 by program element filter module 130, as described herein, may not be limited to any specific value and/or any specific location in program 30; Embodiments of the invention may apply similar methods of filtering of program elements 60 of any type or value, and in relation to any location or position in program code 30.

It may be appreciated by a person skilled in the art, that the process of filtering of program elements 60 by program element filter module 130, as elaborated above and as demonstrated by the aforementioned examples, may be utilized for a plurality of operations, including for example, assigning a value to a variable, passing an argument to a function, providing operands for an operator and the like.

As known in the art, symbols that are declared within a program may be associated with a scope, which may define the boundaries of that symbol's accessibility (e.g., within the code block where the symbol is declared, within a file where the symbol is declared, etc.). For example, currently available programming languages may enable a single symbol or name to refer to a plurality of underlying entities and/or be handled differently throughout the program, depending on that symbol's scope. This concept may be used, for example, to provide data encapsulation and reduction of symbol name clutter.

According to some embodiments of the invention, program storage module 160 may store program code 30B in a hierarchical, structured program code model 165, and may maintain a symbol table 161 for each program block in program code model 165. In other words, system 100 may maintain one or more symbol scope tables 161, defining a scope of each program element 51 within program code 30, and may use the one or more symbol scope tables 161 to detect conflicts among program elements 51 within the program code 30

For example, program storage module 160 may maintain a first symbol table 161 for symbols that are declared in a first program block, pertaining to a function (e.g., the ‘max’ function of Example 1), and maintain a second symbol table 161 for symbols that are declared in a second program block, pertaining to a condition (e.g., the ‘if’ statement of Example 1).

According to some embodiments, declared symbol list 61 may be a unification of all the symbol tables 161 that may be accessible in the scope of insertion point 40.

In other words, a user may declare a symbol (e.g., a new variable name, a new type, etc.) within a program block of structured program code model 165. Program storage module 160 may add the declared symbol as an entry in a symbol table 161 that corresponds to the program block containing the declaration. Thus, when program element filter module 130 looks for symbols that are valid for insertion at a specific location in the program, it may collaborate with structured program code model 165 of intermediary-level code 30B to only search the relevant symbol tables 161. For example, program element filter module 130 may only include in list 50, declared elements (e.g., of list 61) that pertain to the same symbol table 161 as that of the block (e.g., a first block) that includes insertion point 40 and/or any parent program block (e.g., any second block that includes the first block).

As known in the art, currently available programming languages may control data management and encapsulation through declaration of data structures (e.g., structs, classes and the like). Such data structures may include a compounded form of types that may store a group of values, commonly referred to as “members” or “fields”. For example, the data structure ‘Rect’ of the example depicted in FIG. 3A includes four different fields of various types: ‘description’, ‘width’, ‘height’ and ‘filled’. In such conditions, access to the members of a structure may be done through memory pointers (->) or the dot operator (.).

According to some embodiments, in a condition that the insertion point 40 is located at the right operand of the member access operator (e.g., as shown in FIG. 3A), program element filter module 130 may get the type of the data structure (e.g., Rect, the type of the left operand, rects[i]). In this example, program element filter module 130 may not scan the symbols pertaining to the table 161 corresponding to the block or the scope where the operator is used. Instead, program element filter module 130 may scan the symbol table 161 of the corresponding program block of the type declaration (e.g., where the fields of the data structure are declared), so as to present the relevant members (e.g., ‘width’, ‘height’) as valid selectable program elements 51.

It may be appreciated by a person skilled in the art that embodiments of the invention may thus provide an improvement over currently available systems that may utilize “code completion” for computer-assisted programming Currently available systems may “blindly” suggest all the members of a structure for completion, due to the fact that they apply their search logic on the front-end high-level program code. In other words, in order to apply the same capabilities as elaborated herein, currently available systems would need to perform compilation of the front-end code. In contrast, program element filter module 130 of the present invention may apply the search logic on the back-end intermediary code, as it is built and manifested by the structured program code model 165, and may thus not require any compilation, and may produce program code 30 that is devoid of syntactical and grammatical errors.

As known in the art, currently available programming languages may support data hiding, or access control (e.g., by declaring a member of a data structure as ‘public’ or ‘private’).

Embodiments of the invention may suggest insertion of a program element 51 into program code 30, based on such access control or privacy level. For example, assume that a program element 60 that is a member of a data structure, is declared as ‘private’. In this condition, element filter module 130 may only include said program element 60 as a valid program element 51 in suggestion list 50, if insertion point 40 is located inside the same scope (e.g., in the same program block) as the declaration of the data structure.

As known in the art, currently available object oriented programming languages may use objects that encapsulate data (commonly referred to as ‘properties’) as well as functionality (commonly referred to as ‘methods’). Such objects may belong to object classes, which may inherit the interface of another class (commonly referred to as ‘parent’ classes or ‘superclass’). For example, a class defining a ‘dog’ may be a subclass of a parent class defining an ‘animal’, and may inherit one or more members of the parent ‘animal’ class.

Therefore, and according to some embodiments, in a condition that insertion point 40 is located at a position adjacent to a member access operator (e.g., the dot(.) operator) of an object (e.g., an instance of class ‘dog’), element filter module 130 may scan program elements 60 that are members of that object's class (e.g., members of ‘dog’), as well as program elements 60 that are members of its parent class(es) or superclass(es) (e.g., members of ‘animal’), to include them in list 50.

Additionally, or alternatively, when checking for type compatibility, element filter module 130 may allow instantiations of objects of a subclass (e.g., ‘dog’) to be inserted wherever its superclass (e.g., ‘animal’) is required.

As known in the art, in some programming languages, type compatibility may be achieved by adopting protocols or traits. For example, a protocol may be used to declare that a specific compound type (e.g., the ‘dog’ class) may include certain members, regardless of the type from which that type inherits (e.g., the ‘animal’ class). According to some embodiments of the invention, wherever a specific type is required to conform to said protocol, element filter module 130 may include, as valid, selectable program elements 51 of list 50, only available symbols 60 that may be treated as having that same type, according to the rules (e.g., in rules' data structure 131) of the programming language in use.

As elaborated herein, embodiments of the invention may enable a user to insert a program element 51 to a program code 30 by choosing it from a list 50 of valid program elements. Said list 50 may be produced by the program element filter module 130.

Element insertion module 140 may receive selected program element 51 with all the information that may be required to insert it to program code 30. This information may include the type of the selected program element 51, and the location (e.g., location of insertion point 40) in the program (e.g., within structured program code model 165 of intermediate-level program code 30B) to insert it. Program element 51 may also include reference to one or more other program elements 51 (e.g., variables, types, functions, code-blocks, etc.) which may already reside in program code 30.

According to some embodiments, element insertion module 140 may create a new code block, that may include or correspond to a body of the inserted element 51. For example, in a condition that the inserted program element 51 is a statement which requires an adjoint program block (as in the case of a function declaration, a loop statement, condition statement and the like), element insertion module 140 may create a new, corresponding code block, and may insert the block into program code 30.

According to some embodiments, element insertion module 140 may be configured to insert one or more placeholder program elements 51 that may correspond to at least one program element 51, selected (e.g., by a user) for insertion. Such placeholder program elements 51 may, for example, describe or represent one or more sub-elements, that pertain to the selected program element 51. The term “placeholder” may be used in this context to indicate a special kind of program element 51 that may not represent an executable element of program code 30. A placeholder program element 51 may be inserted, for example, in place of an element which is required but has not yet been provided by the user. According to some embodiments, the user may be required to replace placeholder program elements 51 with a valid program element 51 from list 50 before the program could be executed. According to some embodiments, placeholder program elements 51 may be displayed (e.g., on a screen, by program code display module 110) with a special appearance (e.g., a predefined font, color, style and/or size) to indicate that it is not an executable portion of program code 30.

For example, assume that a user has selected to insert a program element 51 that is a ‘return’ statement inside the body of a function, and that the function is declared as such that returns a value. In this condition, element insertion module 140 may insert a program element 51 that may be or may include a value placeholder element.

In another example, in a condition that selected program element 51 includes a reference to a declared symbol 61, such as a function call, element insertion module 140 may collaborate with program storage module 160, and look into the block table 161 corresponding to the declaration of the called function. Element insertion module 140 may subsequently insert, into program code 30, at the location insertion position 40, a first program element 51 that is a reference (a “call”) to said function, and also insert therein a placeholder program element 51 that may include value placeholders (e.g., default values, blank spaces, etc.) for the arguments that are expected by the called function.

Embodiments of the invention may enable a user to insert one or more program elements 51 when at least one sub-element of the one or more program elements 51 already exists in program code 30. In such conditions, element insertion module 140 may be adapted to modify the structure of the code model 165, so as to reflect this change.

For example, a user may choose to insert a logical negation operator (!) before a Boolean value. In this condition the Boolean value may be regarded as an operand of the negation operator. Thus, element insertion module 140 may be configured to modify the structure of the code model 165 such that the negation operator (!) program element may take the place of the Boolean value element, and the Boolean value element may be moved down the hierarchy of code model 165 to become a sub-element of the operator element.

In another example, a user may choose to insert a math multiplication operator (*) after a numeric value. In this condition, the numeric value element may be regarded as the left operand of the multiplication operator. Element insertion module 140 may be configured to modify the structure of the code model 165 by inserting a placeholder program element 51 to indicate the required insertion of the right-side operand of the multiplication operator.

According to some embodiments, after inserting an element, element insertion module 140 may prompt location marking module 120 to place insertion point 40 after the newly inserted program element, to make it convenient for the user to insert additional elements.

Additionally, or alternatively, if the inserted program element 51 is or includes a placeholder program element 51, element insertion module 140 may prompt location marking module 120 to highlight the placeholder, so as to indicate (e.g., to the user) that placeholder program element 51 needs to be modified (e.g., have default fields replaced by executable values).

As elaborated herein, embodiments of the present invention may allow a user to create program code 30 solely by selecting to insert one or more program elements 51 from a list 50 of suggested program elements 51 that are valid for a specific insertion point 40. In a similar approach, embodiments of the present invention may enable a user to select one or more editing actions 81, from a list 80 of suggested valid actions 81 on program code 30. The suggested valid actions 81 may be regarded as valid in a sense that embodiments of the invention may only suggest editing actions 81 that are applicable, according to rules' data structure 131 of the relevant programming language and/or to the structured program code model 165 of intermediary-level program code 30B. Thus, embodiments of the invention may limit the user's actions, so as to avoid errors (e.g., syntax errors and/or grammatical errors) in program code 30.

According to some embodiments of the invention a user may mark a location 40′ of an existing program element 51 in program code 30A, e.g., so as to highlight at least one program element 51. For example, the at least one existing program element 51 in program code 30 may be highlighted (e.g., having a different color) by insertion indicator 41. Location marking module 120 may subsequently produce at least one insertion point data element 40 (e.g., 40A, 40B) as elaborated above that indicates, or relates to the at least one highlighted program element 51.

Auxiliary module 180 may then receive the at least one insertion location 40 from location marking module 120 that indicates at least one specific program element 51 in program code 30. Auxiliary module 180 may produce a list 80 of one or more selectable actions 81 that are valid for application at said insertion location 40, based on a type of the at least one indicated program element 51. For example, in a condition that indicated program element 51 is a symbol name in a declaration of a function, reserved list 80 may include a selectable or optional action of renaming the program element 51 (e.g., the symbol name of the declared function). In contrast, in a condition that indicated program element 51 is, for example, a statement comprising a reserved keyword, or a program block, reserved list 80 may not include a selectable action of renaming the program element 51. Subsequently, as elaborated herein, auxiliary module 180 may receive, from the user, a selection of at least one selectable action 81 of the list of selectable actions 80 and may applying the at least one selected action 81 on program code 30, at said insertion location 40, in accordance with the one or more rules (e.g., within rules' data structure 131) of the programming language, as elaborated in the examples herein. It may be appreciated by a person skilled in the art that the list of rules 131, and hence the subsequent application of actions 81 according to these rules may not be exhaustive. Therefore the examples provided herein should be regarded as non-limiting examples of implementations. Additional forms of application of selected actions 81 on program code 30 may also be possible.

According to some embodiments, the list of selectable actions may include, for example, setting and/or changing a value of at least one indicated program element 51 in program code 30, naming a symbol of an indicated program element 51, changing a symbol (e.g., a name) of at least one indicated program element 51 in program code 30, omitting or deleting at least one indicated program element 51 from program code 30, copying at least one indicated program element 51 in program code 3, moving at least one indicated program element 51 in the program code 30, and the like.

According to some embodiments, list 80 may be presented (e.g., on a screen) as a contextual menu (e.g., following a mouse right-click), enabling a selection of one or more actions 81. The term ‘contextual’ may indicate herein that list 80 may be produced and/or presented differently, depending on the location of the corresponding insertion point 40. For example, in a first condition, insertion point 40 may relate to a first highlighted program element 51, and list 80 may include one or more actions 81 that may be valid for implementation on the first program element 51, and in a second condition, insertion point 40 may relate to a second highlighted program element 51, and list 80 may include one or more actions 81 that may be valid for implementation on the second program element 51.

According to some embodiments, auxiliary module 180 may receive, from the user (e.g., via input device 7 of FIG. 1) a selection of at least one action 81 of the list of valid selectable actions 80, and may apply the at least one action on program code 30, at said insertion location.

According to some embodiments of the invention, at least one program element 51 may define or describe a literal value, such as a string (e.g., “hello world”), a number (e.g., 42) and the like. Embodiments of the invention may enable a user to enter (e.g., via input device 7 of FIG. 1) such literal values, for example by typing them and/or by selecting them from a predefined set of values.

For example, when a program element 51 that is a literal value element is inserted into the program, it may initially be assigned a default value, such as an empty string (“”) or a null (0) value. According to some embodiments, program code display module 110 may be adapted to prompt the user to enter a value (e.g., by presenting a dialog with an input text field), so as to insert said value into program code 30.

In another example, a user may mark one or more locations 40′ of existing program elements 51 in program code 30A, e.g., so as to highlight the relevant program elements 51. As elaborated herein (e.g., in relation to auxiliary module 180), auxiliary module 180 may be adapted to subsequently present a list 81 of actions 80 that may be applied on the one or more highlighted program elements 51, and may enable a user to selecting the action (e.g., a modification action) from the list, for example by double-clicking the selected option.

According to some embodiments, auxiliary module may be adapted to check whether the entered value fits the constraints of the value type before the value entered by the user may be set in the program. For example, a value of type ‘unsigned integer’ can only contain numbers in the range 0 to 2³²−1, without a sign symbol and without a decimal point. Therefore, auxiliary module 180 may refuse or prevent insertion of program elements 51 with values that exceed such constraints.

In another example, in certain programming languages, string values may be subject to various constraints. For example, string values may be limited in length, not be able to store specific characters, etc. In such conditions, auxiliary module 180 may refuse or prevent insertion of program elements 51 that exceed such constraints.

In another example, certain programming languages may store special characters that may be displayed using what is commonly referred to as an “escape sequence”. For example, if a string contains a newline character, it may be displayed using the sequence “\n”. In order to maintain code compatibility, reverse translation module 170 may use such escape sequences when creating a textual representation of string literal elements in program code 30A.

As known in the art, program elements containing symbol declarations, such as variables, functions, or types, need to include a name for the declared symbol. In addition, most languages impose restrictions on symbol names. For example, symbol names may need to begin with a letter, not contain spaces or special characters, not replicate keywords of the programming language, and the like.

According to some embodiments of the invention, auxiliary module 180 may enable a user to type in a symbol name (e.g., a new symbol name), and may validate the newly received (e.g., typed) symbol name, in accordance with one or more rules (e.g., of rules' data structure 131) of the programming language to ensure that the symbol name complies with said rules, before setting the newly received name in program code 30. Subsequently, auxiliary module 180 may insert the newly received symbol name into the program code, based on said validation (e.g., if the validation was successful).

According to some embodiments, auxiliary module 180 may perform one or more types of validation for naming and/or renaming a program element 51 symbol, including for example, validating the newly received symbol name to avoid a condition of ambiguity in the program code; validating the newly received symbol name to avoid usage of reserved keywords; and validating the newly received symbol name to avoid usage of illegal symbols, as elaborated herein.

It may be appreciated by a person skilled in the art that embodiments of the invention may include an improvement over currently available systems for computer-assisted programming, as the inserted program element 51 symbol names may be introduced into structured program code model 165 of the intermediary program code 30B, and thus may not need to be parsed. Therefore, programming language restrictions pertaining to symbol names may be bypassed, or may not be applied altogether.

Nevertheless, in order to maintain code compatibility of program code 30A (e.g., so as to execute program code 30A on a third-party system using a proprietary compiler), and avoid confusion, embodiments of the invention may include assertion of said restrictions by auxiliary module 180.

According to some embodiments, in a condition that a user enters (e.g., types in, selects, etc.) a first symbol name, auxiliary module 180 may be configured to ensure that the first name does not conflict (e.g., be identical to) a second symbol name that already exists in the same code block of structured program code model 165.

According to some embodiments a user may choose (e.g., via actions' list 80) to rename a symbol name of a first program element 51 that is already included or declared in program code 30. In this condition, auxiliary module 180 may be configured to validate or check the newly entered symbol name in order to avoid a condition of ambiguity, and insert the renamed symbol into program code 30B based on said validation.

For example, auxiliary module 180 may verify that program elements 51 of program code 30 do not refer to a second program element 51 that resides within their respective program scope, where the symbol name of the second program element 51 is identical to the newly entered symbol name.

For example, if (a) a user chooses to rename a global variable called ‘counter’ to ‘index’; (b) a program element 51 having the symbol name ‘counter’ was already accessed by a method of a class, and (c) the class also included a property named ‘index’, then auxiliary module 180 may prevent the renaming, to avoid a condition of ambiguity (e.g., avoid a condition in which it may be unclear whether the symbol name ‘index’ refers to the global variable or the class property).

According to some embodiments, following renaming of a symbol name, reverse translation module 170 may refresh the high-level textual representation of program code 30A. For example, translation module 170 may refresh the high-level representation of one or more (e.g., each) program element 51 that refers to the renamed symbol, to reflect the renaming of the program element 51 symbol name.

As known in the art, currently available programming methods may enable a programmer to type in a program in the form of source code, and also delete portions of the typed source code, where erroneous deletion of text (e.g., a single character) is likely to break the program. Embodiments of the invention may include an improvement over such currently available programming methods, by managing deletion (and any other editing action) by auxiliary module 180, while ensuring the correctness of the program.

According to some embodiments, when an insertion point 40 indicates at least one specific program element 51 (e.g., when an existing program element 51 in program code 30 is highlighted by insertion indicator 41), a user may choose to delete it, either via the contextual menu of actions' list 80 or by a button or key (such as backspace), as appropriate for the user interface of the used platform. For example, the user may select an action 81 of selectable actions' list 80, that includes deletion of a program element 51 which is indicated by insertion point 40, from the program code. Alternatively, the user may click a backspace key while insertion point 40 is displayed, the element preceding the insertion point may be highlighted (e.g., by insertion indicator 41), and the user can delete it by pressing backspace again.

According to some embodiments, auxiliary module 180 may apply the at least one selected deletion action by: (a) validating the deletion of the indicated program element in accordance with the one or more rules of the programming language, as elaborated herein; and (b) deleting or omitting the indicated program element 51 from program code 30, based on said validation (e.g., if the validation was successful).

According to some embodiments, validating the deletion of a first, indicated program element may include determining whether the first program element includes, in a hierarchical structure, at least one second program element, and deleting the first program element 51 from program code 30 may further include deleting the at least one second program element.

For example, a user may highlight a first program element 51 that contains (e.g., in its hierarchical position in structured program code model 165) one or more second program elements 51 (e.g., sub-elements within structured program code model 165), and may choose to delete the first program element 51. In this condition, auxiliary module 180 may be configured to delete, or omit from program code 30B the first program element 51, as well as one or more (e.g., all) of its sub-elements, e.g., the one or more second program elements 51. For example, if a user chooses to delete an ‘if’ statement, auxiliary module 180 may be configured to delete the corresponding condition element, body block, and any ‘else’ statement that the ‘if’ statement contains.

As known in the art, a first program element may require inclusion of a second program element. For example, a ‘while’ statement requires inclusion of a conditional element. According to some embodiments, auxiliary module 180 may be configured to validate deletion of a first program element, by checking if the first program element 51 (e.g., marked for deletion by a user) is indeed required by a second program element that contains the first program element 51. For example, auxiliary module 180 may be configured to check if (a) the second program element 51 is a parent of the first program element 51 in the hierarchical structured program code model 165, and (b) if the second program element 51 requires the first program element 51 according to the rules' data structure 131 (e.g., as in the example of the ‘while’ statement above). In this condition, the auxiliary module 180 may replace the first data element with a placeholder and may prompt the user to add the required program element at the location of insertion point 40. According to some embodiments, the user may be prevented from executing program code 30 until they replace the placeholder with the required program element (e.g., a conditional expression). It may be appreciated that the user may be prevented from deleting the first program element 51 from program code 30 in any way that is devoid of the auxiliary module's 180 validation process, as described above.

According to some embodiments, auxiliary module 180 may be configured to validate deletion of a first program element, by checking if the first program element 51 (e.g., marked for deletion by a user) is referenced by one or more second program elements 51 in program code 30. For example, auxiliary module 180 may not enable a user to delete a first program element 51 that is a function declaration, if there is at least one second program element 51 that is a statement in program code 30B (beyond the scope of the declared function's body) that calls or refers to that function. It may be appreciated that the user may be prevented from deleting the first program element 51 from program code 30 in any way that is devoid of the auxiliary module's 180 validation process, as described above.

As known in the art, in some situations program elements can be intertwined. For example, a function may be declared as returning an integer type value, and may contain one or more ‘return’ statements with suitable integer values. In this condition, a user should not delete the return type from the function declaration (or, in some languages, replace it with ‘void’), because the ‘return’ statements would become invalid. Neither should they delete the values from the ‘return’ statements since they are required by the function declaration. Another such example is a condition in which a user should not delete an argument in a function declaration, when there are elements in the program which are call or refer to that function and by doing so, pass a value to that argument.

According to some embodiments of the invention, in order to solve such conditions, auxiliary module 180 may be configured to validate deletion of a first program element 51 (e.g., marked for deletion) by checking such intertwining relations between the first program elements 51 and one or more second, intertwined program elements 51 in view of one or more rules (e.g., of rules' data structure 131) of the programming language, and apply the action of deletion on the first program element 51 and on the one or more second, intertwined program elements 51 accordingly. In other words, auxiliary module 180 may be configured to: identifying one or more second program element 51 having intertwined relations with the first, program element 51; and analyze the intertwined relationship between the first, indicated program element 51 and the one or more second program elements 51 in view of the one or more rules (e.g., of rules' data structure 131) of the programming language. auxiliary module 180 may applying the deletion action on the first program element 51 and also on the one or more second, intertwined program elements 51 according to the analysis.

Pertaining to the example of the ‘return’ statements, if a user selects to delete a program element 51 that is the function's return type, auxiliary module 180 may be configured to delete one or more second, intertwining program elements 51 such as the values of the ‘return’ statements.

Pertaining to the example of the function arguments, if a user selects to delete a first program element 51 that is a function's argument, auxiliary module 180 may be configured to delete one or more second, intertwining program element 51 such as the values that correspond to the deleted function's argument, from all the program elements 51 in program code 30 that call the function. Additionally, auxiliary module 180 may produce a notification message, alerting the user of this deletion action.

According to some embodiments of the invention, auxiliary module 180 may enable a user to conveniently move existing program elements 51 from place to place inside program code 30. The process would start by highlighting at least one program element 51 (e.g., a range of program elements 51) in program code 30. The method for highlighting a range of elements may depend on the user's interface, such as shift-click on a keyboard & mouse interface, or long-touch & drag on a touch-screen interface. The at least one existing program element 51 in program code 30 may be highlighted (e.g., have a different color) by insertion indicator 41. Location marking module 120 may subsequently produce at least one insertion point data element 40 (e.g., 40A, 40B) as elaborated above, that indicates, or relates to the at least one highlighted program element 51.

Once the one or more program elements 51 are highlighted, auxiliary module 180 may enable the user to drag and drop them in another location in program code 30. Alternatively, auxiliary module 180 may enable the user to use a cut action, select another location, and then use a paste action to move the one or more program elements 51. It may be appreciated that if the user cuts necessary elements but never pastes them back, the program may become broken. Therefore, according to some embodiments, auxiliary module 180 may not remove the elements during the cut action, but mark them instead (e.g., by a special text style), and move them to another location only after the paste action is performed.

According to some embodiments, auxiliary module 180 may be configured to validate the move action, and only permit or authorize the moving of program elements 51 if the validation is successful. The validation of a moving action may include, for example: (a) determining that the moved program element 51 is not required in its old location in code model 165 (e.g., in a similar manner as discussed above, in relation to authorizing the delete action); (b) determining that the moved program element 51 is valid for insertion its new location in code model 165 (e.g., in a similar manner as discussed above, in relation to program element filter module 130, when producing a list of valid elements for insertion in a marked program location); (c) determining, in a condition that program element 51 is a symbol declaration, that the symbol can be declared (e.g., added to the block's symbol table 161) in its new location, without producing a conflict with an existing symbol; and (d) determining, in a condition that program element 51 is referenced by one or more second program element 51 in the program, that the new location is still within the scope of each of the one or more second, referencing program elements 51. Additional elements of validation of a moving action may also be possible, according to specific implementations.

According to some embodiments once the validation conditions (e.g., as elaborated above) are met, auxiliary module 180 may move the relevant program elements 51 (e.g., as dictated by a user's cut-and-paste action). Subsequently, auxiliary module 180 may collaborate with program storage module 160 to update structured program code model 165 (e.g., the relevant references and symbol tables therein) according to the movement of the one or more program elements 51.

Reference is now made to FIG. 4B, which is a high-level block diagram, depicting a system 100 for computer-assisted computer programming, according to some embodiments of the invention. By comparison with FIG. 4A, it may be observed that system 100 may include a cross-translation module 190, adapted to modify program code 30B, as elaborated herein. Additionally, or alternatively, system 100 may include, or may execute a virtual computing device 195 or a “virtual machine”, as commonly referred to in the art. Additionally, or alternatively, system 100 may not include any of modules 190 and 195 (e.g., as depicted in FIG. 4A), but may be associated, or communicatively connected (e.g., via a computer network, such as the internet) to at least one of modules 190 and 195 that may, for example, be executed on a remote computing device (such as element 1 of FIG. 1).

As elaborated herein, program code 30B is stored (e.g., in program storage module 160) in an intermediate-level language. Therefore it may be appreciated that program code 30 may be exported, and executed by an executing platform, such as a computing device such as element 1 of FIG. 1. Alternatively, program code 30B may be run or executed on an executing platform such as a virtual computing machine (e.g., element 195), without requiring any compilation or parsing of source code.

According to some embodiments, the executing platform (e.g., virtual computing machine 195) may be configured to ignore user-level information, such as symbol names, comments, scope and/or access restrictions.

According to some embodiments, a statically-typed language may be used, and the executing platform (e.g., virtual machine 195) may thus not need to perform type checking at run-time. The executing platform may be configured to execute the statements of program code 30B one by one, by calling an appropriate block of native code for each statement.

As known by persons skilled in the art, developing a virtual machine may be a labor-intensive process that may involve complex tasks, such as memory management, performance optimization and run-time error handling. According to some embodiments of the invention, system 100 may include a cross-translation module 190, adapted to translate the unique intermediate-level language 30B used when building the program (e.g., stored in program storage module 160) into another, known intermediate-level language 30C, thereby bypassing the difficulty of developing a specialized virtual machine 195.

It may be appreciated by a person skilled in the art that the cross-translation of program code 30B to program code 30C, by cross-translation module 190 should be straight-forward and error free, and may allow program code 30C to be executed by a readily-available virtual machine. For example, the intermediate-level program code 30B may be translated into Java Bytecode 30C, and may thus be executed by a Java virtual machine 195.

Using a virtual machine to execute the program has advantages, but also bears a significant cost in performance. If optimal performance is required, intermediate-level program code 30B may be compiled (e.g., by module 190) into machine code 30D, and may be executed natively. Alternatively, machine code 30D may be adapted to be exported to a remote computing device, and may be exported to be executed on that remote computing device.

It may be appreciated by a person skilled in the art that compilation of program code 30B to program code 30D may not involve front-end compiling, parsing, analyzing source code, and may thus produce no build-time errors. In other words, compilation of program code 30B to program code 30D may only require a back-end compiler to translate program code 30B into executable, architecture-specific machine code 30D (possibly after optimization by a middle-end compiler).

Again, instead of developing a specialized back-end compiler, embodiments of the invention may translate the intermediate-level code 30B (e.g., used in methods of the present invention as elaborated herein) into a second intermediate-level language 30C, for which a back-end compiler (e.g., a third-party back-end compiler) already exists.

A practical example may include using LLVM, a free and widely-used set of compilers. Intermediate-level program code 30B may be translated into a second program code 30C, in a language called LLVM IR (IR stands for Intermediate Representation). Subsequently, program code 30C may be optimized by an LLVM optimizer, and compiled into machine code 30D for specific architectures, using the variety of available LLVM back-end compilers.

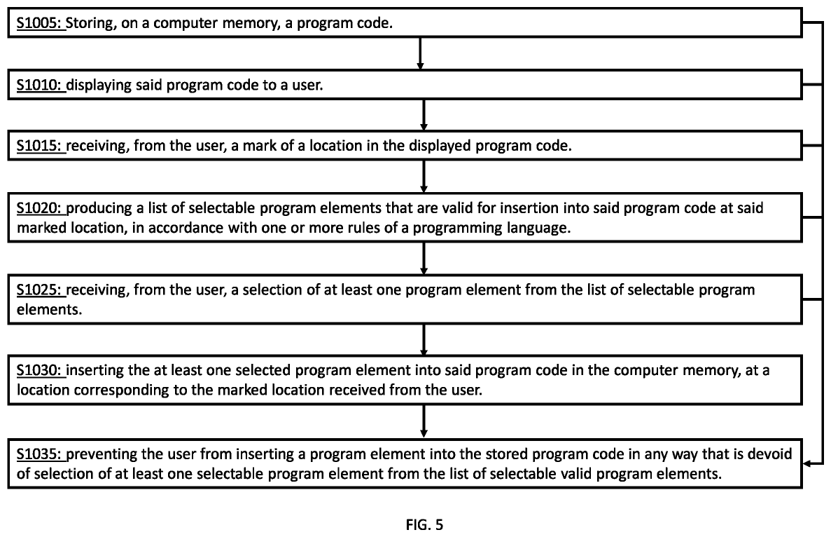

Reference is now made to FIG. 5, which is a flow diagram, depicting a method of computer-assisted programming, according to some embodiments of the invention. According to some embodiments, the method depicted in FIG. 5 may be implemented, as elaborated herein, by system 100 (e.g., as elaborated in relation to FIG. 4AA and FIG. 4AB).

In step S1005, a program code 30 may be stored on a computer memory.

In step S1010, the program code 30 may be displayed to a user (e.g., via output device 8 of FIG. 1, such as a monitor).

In step S1015, a mark of a location in the displayed program code may be received from the user (e.g., via input device 7 of FIG. 1, such as a mouse).

In step S1020, a list 50 of selectable program elements 51 that are valid for insertion into said program code at said marked location 40A, may be produced in accordance with one or more rules 131 of a programming language.

In step S1025, a selection of at least one program element 51 from the list of selectable program elements 50 may be received from the user.

In step S1030, the at least one selected program element 51 may be inserted into the program code 30 in the computer memory (e.g., element 4 of FIG. 1), at a location 40B corresponding to the marked location 40A received from the user.

In step S1035, embodiments of the invention may prevent the user from inserting a program element 51 into the stored program code 30B in any way that is devoid of selection of at least one selectable program element 51 from the list 50 of selectable valid program elements, as elaborated herein. It may be appreciated, as demonstrated by the arrows in FIG. 5, that embodiments of the invention may not limit step S1035 to any specific point in time. In other words, embodiments of the invention may continuously (e.g., throughout the process of computer-assisted programming) prevent the user from inserting program element into the stored program code by bypassing the selection of a valid program element from the suggested list of elements.

As elaborated herein, embodiments of the invention provide a practical, technological application for computer-assisted production of error free program code. As also elaborated throughout this document, and embodiments of the invention include a plentitude of improvements over currently available systems and methods of computer programming.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1.-33. (canceled)

34. A computing device configured to generate a program code, the computing device comprising a computing chip, configured to:
maintain, on a computer memory a first representation of a program code;
translate the first representation of the program code to produce a second representation of the program code;
display the second representation of the program code on a user interface;
produce at least one list of selectable program elements that are valid for insertion into the program code at a marked location;
receive, through the user interface, a selection of at least one selectable program element from the list of selectable program elements;
insert the at least one selectable program element into the first representation of the program code, at the marked location; and
display an update of the second representation of the program code on the user interface, wherein the update reflects the change in the first representation of the program code.

35. The computing device of claim 34, wherein the first representation is formatted as an intermediary level program code representation, and the second representation is formatted as a user intelligible programming language representation.

36. The computing device of claim 35, wherein the computing chip is configured to:
receive, via the user interface, a selection of a first marked location in the user intelligible programming language representation;
identify a second marked location in the intermediary-level program code representation that corresponds to the first marked location;
present, via the user interface, in the user intelligible programming language representation a list of selectable program elements that are valid for insertion at the second marked location; and
receive, via the user interface, the selection of the at least one selectable program element from the list of selectable program elements.

37. The computing device of claim 35, wherein the computing chip is configured to:
execute the intermediary-level program code representation on a computing device without requiring compilation or parsing of source code.

38. The computing device of claim 34, wherein the translation of the first representation of the program code to a second representation of the program results in an error-free code.

39. The computing device of claim 34, wherein the first representation of the program code is configured to be executed by a virtual machine

40. The computing device of claim 34, wherein the first representation of the program code is configured to be transferred to, and executed on other computing devices.

41. The computing device of claim 34, wherein the first representation of the program code is configured to be transferred to and executed on other operating systems.

42. The computing device of claim 34, wherein the computing chip is configured to:
validate a program element in accordance with one or more rules of a programming language; and
insert the program element, being validated, into the at least one list of selectable program elements.

43. The computing device of claim 34, wherein the computing chip is configured to:
create a computer program without typing code.

44. The computing device of claim 34, wherein the computing chip is configured to:
delete an at least one existing program instruction; and
automatically replace the at least one existing program instruction with a placeholder when required to maintain valid program structure.

45. The computing device of claim 34, wherein the computing chip is configured to:
edit an at least one or more existing program instructions, wherein the editing comprises at least one of:
select an existing program instruction from the at least one or more existing program instructions that declare a program symbol; and
rename said program symbol while asserting that the newly entered name is valid for said program symbol according to the language syntax;
select an existing program element which defines a program value and edit said program value while asserting that newly entered value complies with the requirements of the program;
select one or more existing program instructions from the at least one or more existing program instructions and replace the existing one or more program instructions with another program instruction from a displayed list of other program instructions that are valid for insertion in the same location; and
select one or more existing program instructions from the at least one or more existing program instructions and copy and paste the one or more existing program instructions to another location, wherein the one or more existing program instructions are assimilated in said other location and constitute a valid program;

46. The computing device of claim 34, wherein the computing chip is configured to:
select one or more existing program elements from the at least one or more existing program elements and delete the one or more existing program elements;
validate the deletion of the one or more existing program elements in accordance with the one or more rules of the programming language; and
omit the one or more existing program elements from the program code based on the validation.

47. The computing device of claim 34, wherein the computing chip is configured to:
move an at least one indicated program element in the program code;
validate the movement of the at least one indicated program element in accordance with the one or more programming language rules; and
move the at least one indicated program element in the program code based on said validation.

48. The computing device of claim 34, wherein the second representation is formatted as a formal, high-level programming language.

49. A computer-implemented method of computer-assisted programming performed by a computer chip, the method comprising:
maintaining, on a computer memory a first representation of a program code;
translating the first representation of the program code to produce a second representation of the program code;
displaying the second representation of the program code on a user interface;
producing an at least one list of selectable program elements that are valid for insertion into the program code at a marked location;
receiving, through the user interface, a selection of at least one selectable program element from the list of selectable program elements;
inserting the at least one selectable program element into the first representation of the program code, at the marked location; and
displaying an update of the second representation of the program code on the user interface, wherein the update reflects the change in the first representation of the program code.

50. The method of claim 49, wherein the first representation is formatted as an intermediary level program code representation, and the second representation is formatted as a user intelligible programming language representation

51. The method of claim 50, comprising:
receiving, via the user interface, a selection of a first marked location in the user intelligible programming language representation;
identifying a second marked location in the intermediary-level program code representation that corresponds to the first marked location;
presenting via the user interface in the user intelligible programming language representation a list of selectable program elements that are valid for insertion at the second marked location; and
receiving, via the user interface, the selection of the at least one selectable program element from the list of selectable program elements.

52. The method of claim 50, comprising:
executing the intermediary-level program code representation on a computing device without requiring compilation of a source code.

53. The method of claim 49, comprising:
producing an error-free program code.

54. The method of claim 49, comprising:
executing the first representation of the program code by a virtual machine.

55. The method of claim 49, comprising:
transferring the first representation of the program code to other computing devices to be executed on the other computing devices.

56. The method of claim 49, comprising:
transferring and executing the first representation of the program code on other operating systems.

57. The method of claim 49, comprising:
validating a program element in accordance with one or more rules of a programming language; and
inserting the program element, being validated, into the at least one list of selectable program elements.

58. The method of claim 49, comprising:
creating a computer program without typing code.

59. The method of claim 49, comprising:
deleting an at least one existing program instruction; and
automatically replacing the at least one existing program instruction with a placeholder if required to maintain valid program structure.

60. The method of claim 49, comprising:
editing at least one or more existing program instructions, wherein the editing comprises at least one of:
selecting an existing program instruction from the at least one or more existing program instructions which declare a program symbol; and
renaming said program symbol while asserting that the newly entered name is valid for said program symbol according to the language syntax;
selecting an existing program element which defines a program value and editing said program value while asserting that newly entered value complies with the requirements of the program;
selecting one or more existing program instructions from the at least one or more existing program instructions and replacing the existing one or more program instructions with another program instruction from a displayed list of other program instructions that are valid for insertion in the same location; and
selecting one or more existing program instructions from the at least one or more existing program instructions and copying and pasting the one or more existing program instructions to another location, wherein the one or more existing program instructions are assimilated in said other location and constitute a valid program;

61. The method of claim 49, comprising:
selecting one or more existing program elements from the at least one or more existing program elements and deleting the one or more existing program elements;
validating the deletion of the one or more existing program elements in accordance with the one or more rules of the programming language; and
omitting the one or more existing program elements from the program code based on the validation.

62. The method of claim 49, comprising:
moving an at least one indicated program element in the program code;
validating the movement of the at least one indicated program element in accordance with the one or more programming language rules; and
moving the at least one indicated program element in the program code based on said validation.

63. The method of claim 49, wherein the second representation is formatted as a formal, high-level programming language.
